(19) United States
(12) Patent Application Publication
(10) Pub. No.: US 2025/0329248 A1
(43) Pub. Date: Oct. 23, 2025

(54) Protection Security Device with Threatening Individual(s)' Information Registration Capability

(71) Applicant: morteza salimi kachouei, mahshahr (IR)

(72) Inventor: morteza salimi kachouei, mahshahr (IR)

(21) Appl. No.: 18/860,640

(22) PCT Filed: Apr. 27, 2022
(86) PCT No.: PCT/IB2022/053917

§ 371 Date: Oct. 26, 2024

(51) Int. Cl. G08B 25/01; H04W 4/90

(52) U.S. Cl. CPC G08B 25/016; H04W 4/90

(57) ABSTRACT

The present invention includes three inventions, namely A, B, and C, for different applications. Invention A has been designed for personal use. And Inventions B and C have been designed for use in vehicles and houses, respectively. The security device in all of these inventions consists of two parts, a “protection device” and a “receiver”. The protection device collects the information (records text, location, audio, and video information by keyboard, GPS, microphone, and camera) and then sends the collected information to the receiver via the internet online. The receiver is a device on which the information is registered (stored). The information stored in the receiver cannot be observed, accessed, and deleted instantly. Recording the information is activated either manually or automatically. The duty of this invention is to increase the users' security by accelerating the data transfer to the police for helping the users in the case of accidents.

### PRIOR ART

Today, it is very common to use security systems for providing the security of vehicles, houses, and commercial buildings. The invention of “Protection Security Device with Threatening Individual(s)' Information Registration Capability” includes three inventions A, B, and C. Invention A has been designed for personal use. Invention B has been designed for use in vehicles. And Invention C has been designed and presented for use in houses (and commercial applications). In all of these three inventions, the security device is constituted of two parts, namely the protection device and the receiver. The protection device is responsible for collecting information and sending the collected information to the receiver via the internet online. The receiver is a device on which the information is stored. The protection device in each of these inventions can be a single type or a combination of multiple audio, video, and location types or all of them. The present invention has been designed to prevent crimes and provide security for the users. By using the protection device in the present invention and taking the proposed principles (deactivation of instant facilities) into consideration, the users' privacy will be protected completely.

In previous security systems, once a robbery or a crime occurred, the information was prone to be deleted by the criminals while in the present invention, information is stored in a safe place other than the place of crime, thus deleting the information is almost impossible. In the case of using this invention, if an accident occurs for the user, all of the user-related information is provided for the police in a classified manner and based on a predefined process very quickly, such a feature cannot be found in any of the previous inventions. Using the protection device, relying on its predefined processes and new features, causes the criminals to fear to endanger and bother the user and, thereby, leads to the prevention of crimes. The aim of this invention is to provide security and prevent crimes by means of the protection device and the receiver and also by adhering to its proposed principles (deactivation of instant facilities), which cannot be found in any of the previous security systems.

### TECHNICAL FIELD OF THE INVENTION

At least one specification heading is required. Please delete this heading section if it is not applicable to your application. For more information regarding the headings of the specification, please see MPEP 608.01(a).

### BACKGROUND OF THE INVENTION

The present invention can protect users' privacy better than the previous designs, such as video surveillance by Alarm Monitoring Center, and can be widely used for different purposes including personal use, residential use, as well use in vehicles.

Information is stored in the receiver's memory and the receiver is kept in a private and safe place belonging to the user at the service-providing company. In normal conditions, only the user can have access to the receiver so the receiver is inaccessible to others. Also, deactivating the instant facilities will make it impossible for other individuals to get access to the information. Therefore, an advantage of this protection device is that the users' privacy is respected. Sometimes, once a crime or a robbery, such as a home burglary (home robbery), the thieves delete the recorded video and information. In most of the previous inventions, information was stored in a security device so thieves or criminals were likely to get access to the information. But, in the present invention, information is stored in the receiver and a reliable place so that it will be impossible for criminals to get access to the information and delete it. By using this invention, in the case of an accident for the user, the user's information is provided for the police in a classified manner and based on a predefined process very quickly. Such a feature cannot be found in any of the previous inventions.

Home black-box device and system capable of automatic record and video communication

KR101446416B1

This invention relates to a home black box device, and more particularly, to a home black box device which includes a visit signal input button for receiving a visit signal from a visitor; a sensing module for detecting an event signal in a predetermined area; a camera module for collecting image data of an area where the visitor is located; a microphone module for collecting voice data of the area where the visitor is located; a speaker module for delivering voice or alarm information to the visitor; a storage module for storing the image data and audio data. A communication module for transmitting the video data and the audio data to the predetermined user terminal and receiving video or audio data from the predetermined user terminal; And a control module for controlling the start and end of the operation of the camera module, the microphone module, the storage module and the communication module, wherein the control module, the visit signal input button is input, or the sensing module detects a predetermined event signal, the camera module, the microphone module and the storage module are automatically operated to transmit the collected image or voice to the predetermined user terminal through the communication module in real time. This home black box device is capable of automatic recording and real-time video communication. According to this invention, a long distance communication module using a wideband code division multiple access (WCDMA) capable of communicating with a smart device capable of bidirectional mobile communication is provided. A smart device provided with an application program for communicating with the home black box device or the home view to reproduce image data or voice data transmitted from the home black box device or the home view and to make a video call with a visitor in real time.

Apartment security system and its operation method using local area network

KR101935594B1

This invention relates to an apartment security system using a private communications network and an operation method thereof. Specifically, a floor number of a corresponding household number is extracted based on information for a household number obtained through a common interphone during passing through a common gate and a floor number where a corresponding visitor takes off an elevator is extracted from image information transmitted from a security camera. It is quickly determined whether the visitor is a normal household or a normal visitor, or is a visitor having an impure intention (a burglar or the like), and the determination is informed to the surrounding households. When all household members of a household are all absent (empty house), approval is received from the corresponding household, and windows installed in the corresponding household are remotely closed and locked. The security for each household can be further reinforced.

The security system of apartment house using home Black Box, and management method thereof

KR101492506B1

This invention relates to a security system for an apartment house using a home black box, and a method for operating the same. The security system for an apartment house according to this invention can prevent crimes such as sneak thieving by installing a home black box, which stores and transmits an image of the door camera, in each home of an apartment house such as an apartment or a studio apartment; analyzing the acquired image to determine a suspicious situation when a doorbell event occurs and giving the warning to demand the attention of each home or increasing patrols.

Patent for App, Function, Software, and/or Utility that utilize cell phones and its cameras for On-the-road, (driving) recording, home security recording, and phone protection and safety recording

US 2017/0048375 A1

To include black-box function into cell phones with an application, function, software widget, and utility that utilize cell phones which will provide a continuous recording. The cell phones will utilize its front and rear camera to provide on-the-road recording that can be utilized for road accidents and vehicle theft-prevention, served as a security camera at home to monitor and record any suspicious or dangerous activities, and continuous recording which can be used to monitor and prevent any information leak from occurring to other users.

This reference is similar to the present invention in the case that the mobile app is used (it shows the software capability of the present invention), but the only difference is that in the present invention, the information is stored in the receiver while, in this reference, data are stored in the cell phone and, thus, they might be deleted. In this invention, external cameras and microphones can be used too.

Intelligent Home Security System

US 20070182543

This invention relates an intelligent home security system and method for protecting homes by detecting an approach, intelligently deciding for active responses, alarming and contacting the respective person or organization through a communication link. With the associated hardware by applying psychological knowledge and human intelligence, the intelligent home security system and method can significantly reduce the possibility of an intruder breaking-in or even prevent a breaking-in from happening by real-life simulating, reactive real-life simulating, active and intelligent responding; help to identify and track intruders by taking photos at the suitable time, which offers valuable information for crime investigation and eventually reduces the crime rate, in addition to the conventional intruder detection, alarming and reporting to a security monitoring center or the respective person.

Home star security system

US 2012/0008751

The Home Star is an interactive security and communication system for the home which is wired to doors, windows, and other points of entrance, with infrared motion sensors, included to detect home invaders. Once tripped, this alarm sends a silent signal to the authorities and the Home Star command center, ensuring that police back up and support is immediately directed to the location. More than a mere security system, the Home Star provides a complete communication system for the home enabling occupants to place and receive telephone calls, print documents, and road maps, and access other family members, all with a simple press of the activation switch. This, in turn, activates an interactive system of voice prompts which enables the user to execute any number of function-specific commands.

Personal Security System

US 2010/0231378

A personal security system relating to a method of applying remote access to track,

gather data, and receive alerts from a distant personal accessory such as a bracelet or watch. An alert signal is emitted during several scenarios including dramatic changes to adrenaline, traveling to a certain distance threshold, or tampering or attempted removal of the personal accessory. In addition, the alert can only be canceled by the authorized receiver.

Similar to the security systems used for alarm monitoring at homes, . . . , the HELP REQUEST key on the protection device (in the present invention) can be capable of requesting help from the alarm center, yet the protection device and the receiver have more features and capabilities than the previous security systems. Therefore, the protection device and the receiver can be used as a supplement for the previous security systems.

### SUMMARY OF THE INVENTION

The present invention includes three inventions, namely A, B, and C, for different applications. Invention A has been designed for personal use. And Inventions B and C have been designed for use in vehicles and houses, respectively. The security device in all of these inventions consists of two parts, a “protection device” and a “receiver”. The protection device is responsible for collecting information. For this purpose, it records text, location, audio, and video information by keyboard, GPS, microphone, and camera and then sends the recorded information to the receiver via the internet online. This information might have been recorded by the user himself or it might include the information related to the surrounding environment or other individuals, which has been recorded automatically. The receiver is a device on which the information is stored. The receiver is placed in a private place belonging to the user in the security service-providing company and far from the place of crime scene. The information stored in the receiver cannot be observed, accessed, and deleted instantly, thus the receiver provides safe conditions for protecting the user's security and privacy. In the case that the user disappears, the information stored in the receiver can help the police to find the user.

### DESCRIPTION OF THE INVENTION

The invention of “protection security device with threatening individual(s)' information registration capability” includes three inventions, namely A, B, and C that have been designed and presented for different applications. Accordingly, invention A has been presented for personal use. Also, inventions B and C have been presented for use in vehicles and houses (and commercial applications), respectively.

The components of the security device in each of the above-mentioned inventions (A, B, and C) include the “protection device” and the “receiver”. The “protection device” is responsible for collecting information and sending the collected information to the “receiver” online via the internet. The “receiver” is a device on which the information is recorded (registered). The “protection device” for each invention (A, B, and C) can be a single type or a combination of multiple audio, video, and location types or all of them.

The protection device is constituted of a module for registering text data (a keyboard), a module for recording (registering) audio data (a microphone), a module for recording (registering) video data (a camera), a module for location positioning (GPS), and a USB port, all of which are responsible for the registration of the input data. In addition, the protection device has a battery charge display. The input data are temporarily stored on the memory of the protection device. Also, the protection device is equipped with a wireless connection module for connecting to wireless networks, which includes a SIM card that provides an internet connection via cellular networks and sends the input data, immediately after being recorded, to the receiver (that is located in the security services company) online in order to prevent access to data, data deletion, or data theft.

The receiver device is constituted of a wireless connection module for connecting to wireless networks, which includes a SIM card that provides an internet connection via cellular networks and also receives the data online from the protection device and registers on its memory. Besides, the receiver has a DSL wired input port that can receive the data from the internet via wired lines of a local telephone network. Moreover, the receiver device is capable to connect to other wireless internet networks such as WIFI. It works with electrical power but it is also equipped with a battery so that it can continue receiving data even in the case of a power outage.

Several problems found in the previously invented similar designs have been solved in the present invention. In this invention, the information (data) of the threatening person(s) is registered on the memory of the receiver, which is located at a safe place far from the place of crime, online via the internet before or at the time of the occurrence of the crime. Therefore, this information cannot be accessed or deleted by the threatening person, providing safe conditions for the prevention of the crime and the protection of the user. For example, after the occurrence of a robbery in a house where the residents are present, the information of the threatening individuals is registered on the receiver device (which is located at a safe place far from the house), thus the threatening individuals cannot delete the information. A very important feature of the current invention, which none of the previous inventions had, is that in the case of an accident for the user, the classified information related to the user and the threatening person is transferred to the police office very quickly so that police can help the user immediately.

To provide a better understanding of the invention, the three inventions A, B, and C, which have been designed for different applications, are described separately in the following sections.

### Invention A

a. Protection Device for Personal Use (Personal Protection Device)

The protection device for personal use includes multiple text, audio, video, and location types or a combination of them.

### A.1—Text Type Protection Device

The text type protection device (for personal use) is demonstrated in FIG. (1).

Different components of the text type protection device include:

The text type protection device is similar to a cellular phone and has a SIM card, which provides an internet connection via cellular networks and sends the input data, immediately after being registered, to the receiver device online.

The text type protection device can be presented as smartwatches that have SIM cards.

The text type protection device is capable to connect to the internet of wireless networks, . . .

The text type protection device has a keyboard and a screen (for displaying the written information), which can be also designed as a touch keyboard and a touch screen. The keyboard (external or touch) can be used for entering the password to start or stop

the operation.

The protection device has a battery, which can be recharged by a charger (like a cell phone).

The protection device is equipped with a USB port or BLUETOOTH or WIFI through which it can receive the information and then send it to the receiver.

The external keys of the device include:
SWITCH ON/OFF
START/STOP key
REQUEST HELP key
TEST key
INSTANT FACILITIES DEACTIVATION key

Solution-1: It might happen to some people that they are threatened by another person or face a request (demand) associated with an indirect threat from that person but they don't inform the police or even their own family of this event for any reason. The use of the text type protection device is, in fact, aimed to create a completely personal and confidential notebook for the user so that nobody, except the user, can have access to the information in this notebook. According to FIG. (1), when the user writes a message in the text type protection device, the protection device sends the user's message to the receiver via the internet in order to be stored on the receiver. Whenever feeling danger and unsafety or being threatened by another person, the user can, in the case of having the text type protection device, record the name of that person and the relevant event. This information is immediately sent to the receiver and stored on it and, thereby, the user becomes safe from the threats. In the case of the occurrence of a serious accident for the user or in the case of the disappearance of the user, with the request of police or the user's family, the service-providing company presents the recorded information to the police so that the police can help the user quickly. Depending on the user's tendencies at the time of registration (enrollment), the company can disclose the information for police only in the case of the occurrence of events such as the disappearance of the user or after a certain period of time previously determined by the user.

Solution-2: The user can send the desired documents along with comments (explanations) to the receiver via the USB port (or BLUETOOTH or WIFI) in order to be stored on the receiver's memory. For instance, the user can send the documents related to those individuals who have threatened him to the receiver via the USB port of the protection device in order to be stored on the receiver's memory, resulting in a danger-inhibition state for the user.

Solution-3: The user can bold some cases as considerable threats in order to prompt the police to investigate these documents earlier in the case of the occurrence of an accident.

Solution-4: Since the design is a novel and unprecedented one, to clarify the importance of the current protection device, it can be said that after the disappearance or murder of a person, the police investigators will check the last calls, visits, emails, notebooks, or diary of that person. This needs a considerable amount of time for investigating the relatives, witnesses, and documents of that person. But, the use of the current invention provides the police with much more complete information in the shortest time.

How it works:

According to FIG. (1), the only thing that the user should do to register notes and messages in this notebook is to write the message in the protection device and then press START (or SEND) in order that the message is sent to and stored on the receiver.

The text type protection device has a keyboard and a screen to display the written information (data).

The user can send his desired documents to the receiver via the USB port (or BLUETOOTH or WIFI) mounted on the protection device to register them on the receiver's memory.

Text type software instead of text type protection device

Solution-5: A text type software can be presented instead of the text type protection device. This software can be released as mobile phone software or computer software or both of them. The users can send their notes to the receiver by using these software products. For example, the user can use the mobile phone software to register the text information on the receiver, and, thereby, the protection device won't be needed anymore.

### A.2—Audio Type Protection Device

The audio type protection device (for personal use) is shown in FIG. (2).

Different components of the audio type protection device include:

The audio type protection device is similar to cell phones and has a SIM card that provides an internet connection via cellular networks and sends the input data, immediately after being registered, to the receiver online.

The audio type protection device can be presented as smartwatches that have SIM cards.

The audio type protection device is capable to connect to the internet of wireless networks, . . .

It has a keyboard and a screen (for displaying the written information), which can be designed as a touch keyboard and a touch screen.

The keyboard (external or touch) can be used for entering the password to start or stop the operation.

It has a built-in speaker and microphone.

The protection device can be connectable to an external (wired or wireless) microphone.

The protection device has a battery, which can be recharged by a charger (similar to the charger of the cell phones).

The protection device is equipped with a USB port or BLUETOOTH or WIFI through which it can receive information and send it to the receiver.

The external keys of the device include:
SWITCH ON/OFF key
START/STOP key
HELP REQUEST key
TEST key
INSTANT FACILITIES DEACTIVATION key

Solution-6: The audio type protection device is similar to the text type except that instead of text, audio data is sent to the receiver. According to FIG. (2), the audio type protection device records the user's voice as well as the sound of the user's entourage and the environment and, then, sends it to the receiver online via the internet in order to be stored on the receiver's memory. In the audio type, the user can provide safe conditions for himself by reciting the information (features and characteristics) of the individuals or his location and registering it online. The superiority of the audio type protection device over the text type lies in its capability to operate needless of typing so that the user can register the intended information with a higher speed and in any situation. For example, in the case of not being in a good mood or not having enough time for typing the name of the visited person or the location of the meeting, the user can use the audio type protection device to register the information on the receiver by merely reciting the name of the visited person and location of the meeting in the microphone.

Solution-7: The audio type protection device serves as a wireless transmitter for police forces, but the difference is that in the case of using the audio type protection device, even if nobody can hear the voice of the user (police) at the time of hazards, the user's voice is recorded and registered on the receiver online. Therefore, the user (police) can, even in environments beyond the scope of his duty, easily use the audio type protection device and install (mount) a microphone on his clothes; thereby, in the case of being threatened, he can quickly register the information (characteristics and features) of the threatening person as well as his own location on the receiver online. Furthermore, if necessary for the police forces, the protection device can have the capability to call the police center and send the information at the same time in critical conditions so that it can connect to the police center and send an automatic help request only by pressing one button. This type is applicable not only for the police forces but also for individuals with high-risk jobs (at working and non-working hours) or even for ordinary people. In the audio type, the microphone can be put directly on the protection device or can be installed separately on the device in either wired or wireless form.

Solution-8: The user can send his desired documents along with audio comments (explanations) to the receiver via the USB port (or BLUETOOTH or WIFI) on the protection device in order for being stored on the receiver's memory. For instance, the user can send the documents related to the individuals who have threatened him to the receiver via the USB port on the protection device in order to be stored on the receiver's memory, yielding a danger-inhibition state for the user.

Also, the user can bold some cases as considerable threats in order to prompt the police to investigate these documents earlier in the case of the occurrence of an accident.

How it works:

According to FIG. (2), for the audio type, that's enough for the protection device to have the capability of recording and sending sounds. For example, the protection device is similar to a cell phone and includes a SIM card and a microphone so that the SIM card provides an internet connection via cellular networks and, thereby, sends the input information, immediately after being registered, to the receiver online.

How the audio type protection device starts working depends on the user's tendency. As soon as the user switches on the device and presses the START button, the device starts recording and sending the user's voice and the sound of the surrounding environment to the receiver. If there is no energy resource limitation and data transfer limitation, the protection device can, depending on the user's tendency, be used at more times and more places and can, for instance, send the information constantly.

The user can send the desired documents to the receiver via the USB port (or BLUETOOTH or WIFI) on the protection device in order to be stored on the receiver's memory.

Audio type software instead of the audio type protection device

Solution-9: An audio type software can be presented instead of the audio type protection device. This software can be released as mobile phone software or computer software or both of them. The users can send their notes to the receiver by using these software products. For example, the user can use the mobile phone software to register the text information on the receiver, and, thereby, the protection device won't be needed anymore.

### A.3—Video Type Protection Device

The video type protection device (for personal use) is shown in FIG. (3).

Different components of the video type protection device include:

The video type protection device is similar to cell phones and has a SIM card that provides an internet connection via cellular networks and sends the input data, immediately after being registered, to the receiver online.

The video type protection device can be presented as smartwatches that have SIM cards.

The video type protection device is capable to connect to the internet of wireless networks, . . .

This device has a keyboard and a screen (for displaying the written information), which can be designed as a touch keyboard and a touch screen.

The keyboard (external or touch) can be used for entering the password to start or stop the operation.

It has a built-in speaker, microphone, and camera.

The protection device can be connectable to an external (wired or wireless) microphone and camera.

The protection device has a battery, which can be recharged by a charger (similar to the charger of the cell phones).

The protection device is equipped with a USB port or BLUETOOTH or WIFI through which it can receive information and send it to the receiver.

The external keys of the device include:
SWITCH ON/OFF key
START/STOP key
HELP REQUEST key
TEST key
INSTANT FACILITIES DEACTIVATION key

Solution-10: The video type protection device is similar to the audio type except that in this device, in addition to the audio data, the video data are sent to the receiver as well. According to FIG. (3), the video type protection device records the user's voice and video as well as the sound and video of the user's entourage and the environment and, then, sends it to the receiver online via the internet in order to be stored on the receiver's memory. As a consequence of the registration of the information of the threatening person on the receiver's memory, as an inhibitory factor, the user is secured from the threats. The video type protection device is the most complete and the most perfect type in terms of collecting data and information from the user's surrounding environment. For the video type, that's enough for the protection device to have the capability of recording and sending audio and video to the receiver at the same time.

Solution-11: The user can send his desired documents along with video comments (explanations) to the receiver via the USB port (or BLUETOOTH or WIFI) on the protection device in order for being stored on the receiver's memory. For instance, the user can send the threatening individuals-related documents to the receiver via the USB port on the protection device in order to be stored on the receiver's memory, yielding a danger-inhibition state for the user.

Also, the user can bold some cases as considerable threats in order to prompt the police to investigate these documents earlier in the case of the occurrence of an accident.

How it works:

According to FIG. (3), for the video type, that's enough for the protection device to have the capability of recording and sending audio and video. For example, the protection device is similar to a cell phone and includes a SIM card, an internal camera or an external camera (to be mounted on clothes), and meanwhile a microphone. In this case, the data collection is performed by the camera and the microphone and, then, the protection device sends the recorded data to the receiver online via the internet.

How the video type protection device starts working depends on the user's tendency. As soon as the user switches on the device and presses the START button, the device starts recording and sending the user's voice and video as well as the sound and video of the user's surrounding environment to the receiver. If there is no energy resource limitation and data transfer limitation, the protection device can, depending on the user's tendency, be used at more times and more places and can, for instance, send the information constantly.

The user can send the desired documents to the receiver via the USB port (or BLUETOOTH or WIFI) on the protection device in order to be stored on the receiver's memory.

A few points about the cameras

The external cameras are known as body cameras or wearable cameras (also known as body-worn cameras, BWC).

Depending on the user's tendency and need, one or more small external cameras are mounted on the front side or rear (back) side of the individual's body (at desired parts such as clothes, eyeglasses temples, pockets, buttons of clothes, pocket pen, . . . ).

The external cameras can be connected to the protection device via a wireless connection.

Those individuals who usually commute in dark places can use night-vision cameras or cameras that can work both on days and at night.

The camera in the video type can be either mounted directly on the protection device or connected to the protection device via a wired or wireless connection.

### A.4—Location Type Protection Device

The location type protection device (for personal use) is shown in FIG. (4).

Different components of the location type protection device include:

The location type protective device is similar to a cell phone and has a SIM card, which provides an internet connection via cellular networks and, thereby, sends the input data, immediately after being registered, to the receiver device online.

The location type protective device can be presented as the current smartwatches that have SIM cards and GPS.

This device can be connected to the internet of wireless networks, . . .

It has a keyboard and a screen (for displaying the written data), which can be designed as a touch keyboard and a touch screen.

The keyboard (external or touch keyboard) can be used for entering the password in order to start or stop the operation.

This protection device has a battery that can be recharged by a charger (like a cell phone).

The external keys of the device include:
SWITCH ON/OFF key
START/STOP key
HELP REQUEST key
TEST key
INSTANT FACILITIES DEACTIVATION key

Solution-12: The location type protection device is similar to the previous type such as the audio and video types except that instead of audio and video data, data of the user's location are sent to the receiver. According to FIG. (4), the location type protection device determines the user's location and sends it to the receiver online via the internet in order for being stored on the receiver's memory. In this case, the information (features and specifications) of all places to which the user commutes is sent automatically to the receiver's memory; since, in the case of the occurrence of serious accidents for the user or even the disappearance of the user, knowing the places to which the user usually commuted can be very helpful.

How it works:

According to FIG. (4), for the location type protection device, that's enough for the protection device to have the capability of positioning the user's location by means of, for example, GPS and then sending the identified location of the user to the receiver. The location type protection device is similar to a cell phone and includes a SIM card and GPS.

How the location type starts working depends, just like the audio and video types, on the user's tendency. When the user switches on the device and pushes the START button, the device starts locating the user and sending the spatial data to the receiver. Considering the low energy consumption rate of the GPS, the device can send the spatial data either constantly or at short time intervals. In other words, in hazardous conditions, the user can secure his location and make it safe; yet, it is better to always keep the device on the “ON” mode since, in such case, the user is provided with a higher degree of security.

In the location type protection device, in addition to the GPS, other location positioning systems such as GLONASS, cellular networks' antennas, . . . can also be used for identifying and locating the user.

Location type software instead of the location type protection device

Solution-13: A mobile phone location type software can be presented instead of the location type protection device. this software can identify the user's location by GPS or other available methods on mobile phones and, then, send the user's location data to the receiver. In such a case, the protection device won't be needed anymore.

### A.5—Combined Type Protection Device

Solution-14: The combined type protection device (for personal use) is shown in FIG. (5). This protection device can be made based on a combination of two or more different textual, audio, video, and location types. Also, we can make a protection device with capabilities of all types at the same time so that the user can activate or deactivate, depending on his tendency, one or more types. Moreover, the user can buy additional accessories such as an external camera, etc.

The external keys of the protection device:

These external keys are related to all types of the protection device. For a better understanding, please see FIGS. (1) to (5).

### SWITCH ON/OFF Key:

By pressing this key, you can switch on/off the device.

To switch on/off the device, you can use one key or two separate keys.

It is better to set a password for switching on/off the device.

In other words, when the device is recording and sending data to the receiver, you cannot switch it off, in which case you must certainly use a password for switching off the device.

### START Key:

By pressing this key, the protection device records and sends the data to the receiver. For example, when the START key of the combined type protection device is pressed, the user's location is constantly sent to the receiver and registered on it. By speaking into the built-in or external microphone of the device, the user can register his message and, then, the cameras start recording videos or pictures of the user's surrounding environment and sending them to the receiver.

Depending on the user's tendency, starting the protection device's operation may require entering a password. Of course, it is better to set no password for starting the device's operation in order to enable the user to immediately activate the device for recording in sensitive (critical) conditions. In short, by entering the password (e.g. when switching the device on), the user can put the device on “STANDBY” mode so that the device can start recording, whenever needed, by pressing the START key.

In all types of the protection device and all applications and uses except for the text type, if there is no energy consumption limitation and no data transfer limitation for the device, it is better to avoid starting the operation of the device (start recording and sending data) when hazardous conditions will definitely occur; because this device has been designed and made for prevention and can better guarantee the user's security if it is always with the user and constantly send data to the receiver. However, if recording and sending data is postponed to hazardous conditions, then the user might not have enough time for recording the data, resulting consequently in the lower efficiency of the device.

Also, the external START key of the device can be mounted on the user's watch or ring to work on wireless mode.

The device has an external or touch keyboard. The keyboard can be used for entering the password to start or stop the device's operation.

### DATA RECEIPT AND TEST Key:

Once a file is sent to the receiver, the protection device shows the user a data receipt indicating that the “data received and registered” or announces the delivery and receipt of the data by an audio announcement.

It is recommended to activate the data receipt option only at the time of the first operation of the device, in order for testing and making sure of the device's proper function, and certainly to deactivate it afterward. In other words, to test sending data at the first operation of the device, you can use an external key named TEST KEY or a key on the touch keyboard of the screen.

It is not necessary to always use the TEST key at the first operation of the device. The use of this key depends on the user's tendency. However, it is recommended to use this key at the time of the first operation of the device in order to make sure that the data are sent.

Once the TEST key is deactivated, to re-activate it, an optional time interval must be set. Or, the device can be set such that it is impossible to use the TEST key more than once a day. In such a case, the criminals, even in the case of getting access to the device, won't be able to make sure of the improper function of the device or data registration on the device.

It is recommended to avoid registering any data or even the receipt or comments of the data on the protection device's memory storage and, instead, send all of such information to the receiver.

### STOP Key:

By pressing this key, recording and sending data to the receiver will be stopped.

It is better to set a password (in addition to the external STOP key) for stopping the device's operation.

The STOP key can also serve as the START key or you can use the (internal) key on the touch keyboard of the screen.

### INSTANT FACILITIES DEACTIVATION Key:

By using an external key on the protection device, you can activate or deactivate instant view of data, instant download of data, and instant deletion of data (instant facilities). In other words, as soon as this key is pressed, the capability of viewing, downloading, and deleting the data will be immediately disabled. This feature would be very helpful when the user feels a hazard or suspects that his information might be disclosed and revealed or deleted. Therefore, if the user is exposed to a real threat, the criminals won't be able to get access or delete the user's data.

The INSTANT FACILITIES DEACTIVATION key can be in yellow color.

It should be noted that instant facilities are deactivated immediately and instantly but re-activation of them requires two weeks.

### HELP REQUEST Key:

There is a HELP REQUEST key on the protection device (for personal, vehicle, house, . . . applications) that can be activated or deactivated depending on the user's tendency. It is recommended to activate this key.

In the case of being activated, when the user presses the HELP REQUEST key in hazardous conditions, the request is registered on the receiver and, subsequently, the receiver announces the request to the police, service-providing company, user's family (or anybody who has been previously determined by the user) to help the user. The receiver automatically sends, in addition to the help request, the last location of the user to the police, service-providing company, user's family (or anybody who has been previously determined by the user). Please notice that it is the receiver, not the protection device, that sends the help request to the police. The advantage of this feature is that once the HELP REQUEST key is pressed by the user, the protection device might be destroyed for any reason and, thus, might not have enough time for sending the help request and the user's location; while, the receiver is located at a safe place and has enough time for calling or sending SMS to the police and informing the police of the user's location.

Sending a help request from the receiver to police, service-providing companies, family (or any person predetermined by the user) can be done through automatic audio message, text message, via the internet, or by a separate system that has been provided for connection between the receiver and police, . . . . For automatic communication between the receiver and the police, e.g. through an audio message, the receiver can call the nearest police emergency services center.

The HELP REQUEST key can be mounted, in addition to the protection device, on the user's smartwatch, ring, or necklace that is connected to the protection device via a wireless connection.

When the HELP REQUEST key is pressed, all facilities of the instant data view, instant data download, and instant data deletion (instant facilities) must be deactivated so that if the user is exposed to a real threat, the criminals cannot access or delete the user's information.

Depending on the user's tendency at the time of pressing the HELP REQUEST key, in addition to the user's location, additional information and comments can be sent to the police or the company in the form of a text message or even an audio or video connection can be made with the company or the police. For instance, the smartwatch is equipped with a microphone or a camera so the user, when pressing the HELP REQUEST key, can send audio and video comments and explanations to the company or the police in order that the police or the company can make a better evaluation of the nature of the danger and sett of for helping the user. Of course, this case is optional and is not one of the fundamental principles of the device.

In the case of danger, pressing the HELP REQUEST and INSTANT FACILITIES DEACTIVATION keys at the same time can be evaluated as a more serious request for help.

The HELP REQUEST key can be provided in red color.

External wireless keys for START or HELP REQUEST

For this purpose, a ring can be used to work via a wireless connection so that there is a key inside the ring and the user can use the key for starting the operation of the recorder or sending a help request.

The external key can be placed in the user's pocket and work via a wireless connection.

All of the above-mentioned keys are not necessarily external and can be activated by the touch keyboard of the screen.

Automatic START or automatic HELP REQUEST of the device

Solution-15: The automatic operation start of the device occurs through detection of some danger signs such as running, detection of a loud sound such as the user's shouting, detection of the utterance of a specific word (by means of the voice and speech detection technology), detection of a loud sound from the environment or other people, detection of the user's increased heart rate or pulse, etc. For example, the current smartwatches are capable to measure the pulse rate.

For this purpose, the user can set the device in the “Standby” mode so that it can start recording if needed.

The above-mentioned methods can be used not only for starting the operation of the device but also for sending a help request. Assume the following practical examples:

The protection device can measure the user's pulse rate. Thus, in the case of a fast pulse rate, the device starts collecting information and, then, sending it to the receiver.

The protection device can recognize the user's voice so, in the case of detecting the user's loud voice or shouting, it is activated and starts collecting information and sending it to the receiver. In such a case, the user can say the intruder's name and become safe from the existing threats.

The protection device can recognize the user's voice. Thus, in the case of detecting the user's loud voice or utterance of a specific word (that has been predetermined by the user), the device is activated and can, in addition to sending information to the receiver, send a help request to the receiver to call the police.

Another method that can be used in this regard is to equip the protection device or smartwatch with accelerometer sensors that are activated with a fast motion of the user's hands and start sending information or a help request.

### A.6—Smartwatch (or Smart Wristband) as a Personal Protection Device

Solution-16: The personal protection device, for all types of the protection device, can be designed and provided as a smartwatch (or smart wristband). Or as a better alternative, the capabilities and features of the protection device can be added to the capabilities and features of a smartwatch (or smart wristband) that is available in the market. If so, the product will be widely welcomed because numerous features will be added to the smartwatches. For example, the smartwatch will be capable to send the user's location to the receiver, and thus, in the case of the disappearance of the user, his last location has been registered and saved in the receiver.

Different components of the smartwatch as a personal protection device include:

A smartwatch, like the current smartwatches, has a SIM card that provides the internet connection via cellular networks and sends the input information, immediately after being registered, to the receiver device online.

It can be connected to the internet of wireless networks, . . .

It has a touch keyboard and a screen (for displaying the written information or pictures taken by the camera).

The touch keyboard can be used to enter the password for starting or stopping the device's operation.

A smartwatch, like the current smartwatches, is equipped with GPS.

The microphone and camera are installed on the watch.

The smartwatch can be connected to a handsfree, external microphone, and external camera via a wireless connection. For example, the wireless microphone (just like a wireless handsfree) can be mounted on the shirt collar or the wireless body camera can be mounted on the user's clothes.

The smartwatch has a small USB port (e.g. a TYPE-C port) or BLUETOOTH or WIFI through which the user can send documents along with comments to the receiver in order to be stored on the receiver's memory.

The smartwatch, like the commonly used smartwatches, has a battery that can be recharged by a charger.

The smartwatch has a few external keys, including:
SWITCH ON/OFF key
START/STOP key
HELP REQUEST key

All keys of the smartwatches are not necessarily external and can be activated by the touch keyboard of the screen.

The smartwatch as a personal protection device, is capable to send text, audio, video, and location of the user to the receiver. The smartwatch records the voice and video of the user or the sound and video of the entourage and surrounding environment and, then, sends the recorded information to the receiver online via the internet to be stored on the receiver's memory. The registration of the threatening individual's information or the user's location on the receiver's memory, as an inhibitory factor, makes the user safe from the threats.

How it works:

The smartwatch has the capability to locate the user by GPS and also record and send audio, video, and text. For example, the smartwatch has a SIM card, a touch screen, GPS, a camera, and a microphone. In this case, the touch keyboard, camera, and microphone collect information and, then, send the data collected by the protection device to the receiver online via the internet.

The camera can be installed on the smartwatch so that the user can move (rotate) it to record video or take pictures.

Starting the device's operation depends on the user's tendency. When the user switches on the device and presses the START key, the device starts recording the user's voice and video, the sound and video of the surrounding environment, the user's location, and the message written by the user and, then, sends the recorded data to the receiver in order to be stored the receiver's memory. If there is no energy resource limitation and data transfer limitation, the protection device can, depending on the user's tendency, be used at more times and more places and can, for instance, send the information constantly.

For example, the smartwatch sends the user's location to the receiver constantly or at short intervals so that, even in the case of the disappearance of the user, his last location has been saved on the receiver.

The function of the keys is similar to what was mentioned for the personal protection device.

The password can be used to start or stop recording. Also, by entering the password, the user can put the smartwatch in “standby” mode. Then, as soon as the external key is pressed by the user at the desired time, the smartwatch will start recording.

The points stated earlier in the “Personal Protection device” section about using the wireless external keys for starting the device's operation or sending a help request can be also used here for the smartwatch.

Automatic START or automatic HELP REQUEST by the smartwatch

Solution-17: All the points mentioned in the “Personal protection device” section about the capability of automatic operation start or automatic help request can also apply true here for the smartwatch. As mentioned earlier, the automatic operation start of the device occurs through detection of some danger signs such as running, detection of a loud sound such as the user's shouting, detection of the utterance of a specific word (by means of the voice and speech detection technology), detection of a loud sound from the environment or other people, detection of the user's increased heart rate or pulse, etc. For example, the current smartwatches are capable to measure the pulse rate. For this purpose, the user can set the device in the “Standby” mode so that it can start recording if needed. The above-mentioned methods can be used not only for starting the operation of the device but also for sending a help request. For example, modern smartwatches are capable to measure the pulse rate so that as soon as the user's pulse rate is elevated, the smartwatch starts collecting information and, then, sending it to the receiver.

### A.7—Key Holder as a Personal Protection Device

Solution-18: The personal protection device can be designed and provided as a keyring or key holder on which the user hangs or attaches his car key or house keys and can hold it in his hand or hang it on his belt. The keyring as a personal protection device is shown in FIG. (6). All the points expressed about the personal protection device and smartwatch can also apply true for the keyring. For example, in the video type case, the camera can be mounted on the keyring so that the user can move or rotate it to record video or take pictures. The keyring as a personal protection device is equipped with GPS and can locate the user and send his location to the receiver constantly or at short intervals so that even if the user is disappeared, his last location can be presented to the police.

Receiver device

A receiver is a device that receives the information from the protection device via the internet or other communication methods and then stores the received data on its memory. The receiver is capable to receive and store data.

Features of the receiver device

The receiver device is shown in FIG. (7). The receiver device is capable to receive the user's location, video, audio, and text data from the protection device, smartwatch, etc. The receiver has a SIM card that provides the internet connection via the cellular networks and, thereby, receives the information from the protection device online and, then, stores the received data on its memory. Moreover, the receiver device has a DSL wired input port that can receive data from the internet via the wired lines of a local telephone network. It is better for the receiver to receive data from several methods because, in this case, even if one of the methods is disordered, the receiver will be able to automatically shift to another method for receiving data.

One or more internet service provider networks can be set for the receiver. These networks can be wired or wireless such as WIFI.

According to FIG. (7), different components of the receiver device include:

The receiver device is similar to a special computer with a capability to receive information, which is constituted of a CPU, memory, SIM card, . . .

The receiver device has a SIM card that provides the internet connection via cellular networks and receives data from the protection device online.

The receiver device has a DSL wired input port that can receive data from the internet through the wired lines of a local telephone network.

The receiver device has a touch keyboard and a screen for displaying the stored data.

The receiver device can have no screen or can have a small and simple screen. In this case, in order to display the data, the receiver can be connected, in addition to the protection device and other access methods, to a monitor, a computer, or a mobile phone.

When the user wants to review the receiver's data, he can use the touch keyboard for entering the password to start working with the receiver.

The receiver is equipped with GPS so that if it is lost, its location can be detected via the mobile phone of the user (or the company).

The receiver has a loudspeaker that can be connected to a handsfree.

The receiver device has a memory. The storage capacity of the receiver's memory depends on the user's protection device model. For example, the text type sample has a smaller memory than the video type sample.

The receiver device works with electrical power. It has also a battery so that it can continue working and receiving data in the case of a power outage. The battery can be recharged by a charger or by being plugged in.

The receiver device has a few external keys (which can be either external or touch), including:
SWITCH ON/OFF key
HELP REQUEST key
INSTANT FACILITIES DEACTIVATION key

Depending on the user's tendency, the user can request for the deactivation of instant facilities by pressing the INSTANT FACILITIES DEACTIVATION key. Deactivating the instant facilities in the receiver device will disable the capability of instant downloading and instant deletion of the files.

How it works:

According to FIG. (7), the receiver device starts working by switching on and activating the device. Then, the receiver device will be ready for receiving data from the protection device (or smartwatch,) and registering it on its memory. The receiver must be constantly on to register the data online.

Receiver device keeping place

Solution-19: Each user's receiver device is kept in a safe and private place belonging to the user in the service-providing company. Normally, the receiver is accessible only for the user. The receiver's place in the service-providing company is similar to a personal and private box in the bank safe deposit box, which is completely private and confidential. In the case of an accident for the user, this private box is opened and its information (data) content is revealed only for the police or the individuals previously determined by the user.

The receiver's keeping place, just like the rental bank safe deposit box, can have a lock so that merely the user can open (unlock) it.

Depending on the requirements of the receiver hardware, the keeping place might need an air-conditioning (ventilation) system.

It is recommended that the service-providing company shoulders only the duty of providing electrical power and internet connection and takes no role in receiving and registering information so that, in other words, the company has no access to the users' information.

Personal (individual) receiver

In general, a receiver belonging to a user will be capable to receive information only from the protection device that is related to the same user. The points mentioned about the proposed design refer to this type of receiver and often mean a personal receiver.

Combined receiver

In a specific case, the information of multiple individuals, e.g. members of a family, can be stored in a combined receiver instead of a personal receiver device. For example, this type of receiver can be used for registering the information of multiple personal protection devices that belong to the members of a family and also the protection device of their house.

In this case, each person can use his own password for accessing and examining (reviewing) his own information. Also, this receiver that belongs, for example, to a family or a company can be used for recording the data such as the data of the cameras of that company or cameras of that family's house. The advantage of this type of receiver is that it will probably incur lower costs.

For personal cases, it is recommended to store information on the personal receivers due to the privacy protection considerations.

The second mode of the receiver: portable receiver device

Solution-20: The receiver device belonging to a person can be designed and provided in portable mode, in which case the user will be able to change its location. Therefore, the user can keep the receiver in any place other than the company. For example, the user can keep the receiver at home or any other place that he wants.

It is recommended to avoid taking the receiver out of the company. However, in the case of need for taking the receiver out of the company, the user can do three effective actions:

Before taking out the receiver, the user can make a backup file of the receiver's data and store it on an HDD and then keep the HDD in his own private box in the service-providing company.

The user keeps or hides the receiver at home or in a bank safe deposit box. If so, the user can inform the service-providing company of the receiver's location by an SMS, an audio message, or an email via an automatic system. In this case, if an accident happens for the user, the receiver's location will be declared for the police to facilitate faster access to it. The receiver, if portable, can be kept not only in the service-providing company but also even in the bank safe deposit box, in which case it will be enough to supply electrical power and an internet connection for the receiver in the bank safe box or to put a SIM card in the receiver. Nevertheless, it is recommended to keep the receiver in the security service-providing company in order to facilitate the police's faster access to the receiver.

There is another possible case for taking the receiver out of the company, in which if the user is exposed to danger, he can press the HELP REQUEST key on the receiver or the protection device in order to send the data stored on the receiver's memory to the company's computer. If so, the data will be sent based on a time priority in a last-to-first order or the important data that have been previously emphasized by the user will be sent. So, in the case of an accident for the user, the company will inform the police.

The receiver is also equipped with GPS. Thus, if the receiver is lost or an accident happens to the user, the receiver's location data will be accessible via the cellphone of the user or the company.

The third mode of the receiver: the central computer of the service-providing company as the receiver device

Solution-21: In this mode, the data sent by the protection devices of all users is received by only a big central computer in the service-providing company and then stored in a classified form on a general memory. Then, each user, by using a password, is allowed to access, download, or delete his own data.

The fourth mode of the receiver: the cloud space as the receiver device

Solution-22: The cloud space can be used as the receiver for storing data. In this case, the data sent by the protection devices of all users are stored in the cloud space. The cloud spaces that are currently used can be hacked and are associated with problems in terms of user privacy.

The difference between the cloud space in the present invention and the previous instances is that taking the proposed principles into consideration in this invention has prevented the accessibility and instant download or deletion of data, resulting in better protection of the users' privacy.

The fifth mode of the receiver: a separate memory for each user as the receiver device

Solution-23: In this mode, the receiver has only a computer memory (hard disc and there is a separate memory for each user. The data sent by the protection devices of all users is received only by a big central computer in the company. Afterward, the received data are processed and then stored in a classified form on the separate memories of the users. The memory allocated for each user is placed in the private box of that user in the service-providing company so that only the user will have physical access to it.

The protection device can be used in many other cases including various vehicles, motorbikes, as well as residential, commercial, and office complexes such as houses, shops, bans, etc. Some of these cases are described in the following sections.

### Invention B

### B—Protection Device for use in Vehicles Such as Automobiles, Motorbikes, . . .

Solution-24: The protection device for use in vehicles such as automobiles, motorbikes, . . . is shown in FIG. (8). The user might not like to carry the protection device personally with himself, in which case, by applying the device in his vehicle, he can utilize the features of the personal protection device to some extent. For example, registration of threats, meetings, events, and dangerous situations can be done by the audio or text type protection device. The user's commute locations can be registered by the location type protection device. And finally, recording videos of the individuals and places surrounding the user inside and outside the vehicle can be done by the video type protection device. These features altogether can provide a safe space for users. The presence of the protection device in the vehicle will cause the criminals to fear from intruding and bothering the vehicle owner and, thus, avoid stealing the vehicle.

The protection device for use in vehicles such as automobiles, motorbikes, . . . may be a single type or a combination of some of the audio, video, and location types or all of them. Furthermore, a combined protection device can have the features of all types at the same time. Thus, the user, if willing, can activate or deactivate one or more types.

According to FIG. (8), the protection device for use in vehicles is constituted of the following components:

Similar to a cellphone, this device has a SIM card that provides the internet connection via the cellular network and sends the input data, immediately after being registered, to the receiver device online.

It is capable to be connected to the internet of wireless networks, . . .

It has a keyboard and a screen (for displaying the written information or camera pictures). The keyboard and the screen can be designed and provided in touch mode.

The keyboard, (touch or external) can be used to enter the password for starting or stopping the device operation.

This device is equipped with GPS, loudspeaker, microphone, and camera on the device.

It can be connected to an external microphone and camera (via a wireless or wired connection).

The protection device works with the vehicle's battery. It has also an extra battery that is recharged automatically so that if the battery is deactivated, the vehicle can continue working.

This device has a USB port or BLUETOOTH or WIFI through which it can receive the data and send to the receiver.

The external keys of the device include:
SWITCH ON/OFF key
START/STOP key
HELP REQUEST key
TEST key
INSTANT FACILITIES DEACTIVATION key

The place of the protection device components for use in vehicles

The places of installation of the device components, including the screen, camera, microphone, GPS, . . . , are as follows:

The screen replaces the screen that is commonly used in vehicles for navigation. So, in addition to the duties of the previous device screen (e.g. navigation), it works as the screen of the protection device too.

The screen can be mounted on the first day in the factory. Besides, for vehicles that originally have no screen (e.g. since the date manufactured in the factory), the screen can be installed separately.

The main part of the protection device, in which the components such as the GPS and the SIM card are embedded, is placed in the internal space behind the screen. Also, it can be manufactured separately and then installed in the desired place (e.g. under the speedometer gauge). In this case, the protection device can connect to other components, such as the screen, via a wired or wireless connection.

The camera can be mounted inside or outside the vehicle. However, it is recommended to mount it on both parts.

To record videos (or take pictures) from inside the vehicle, the camera can be mounted on the protection device or above the screen.

To record videos (or take pictures) from outside the vehicle, the camera can be mounted on the internal side of the windshield or on the vehicle's roof. The camera must be rotatable so that it can record videos from the side that the user gets off the vehicle up to the farthest point within the range of the camera.

The microphone can be mounted inside or outside the vehicle or both of them.

The microphone, if inside the vehicle, can be mounted on the protection device or above the screen.

Moreover, one or more microphones can be mounted inside the vehicle close to the steering wheel (to record the driver's (user's) voice) and close to other seats as well.

How it works:

According to FIG. (8), the protection device should be capable to record and send text, user's location, audio, and video. In this case, the keyboard, GPS, camera, and microphone collect data and then send the recorded data to the receiver via the internet online.

How the protection device starts working depends on the user's tendency. Accordingly, when the user switches on the device and presses the START key, the device starts recording and sending the user's location, video, and audio as well as the sound and picture of the surrounding environment to the receiver in order to be registered on the receiver. Considering the unlimited resource for the energy requirement of the protection device, if there is no limitation for data transfer in the vehicle, the device can, depending on the user's tendency, send the data constantly after being switched on and starting its operation.

An external key (a START key) can be considered for starting the device operation. However, the device must still require a password for starting its operation.

Also, the user can put the device in the “Standby” mode. Then, by pressing an external key by the user at the desired time, the device will start recording.

Solution-25: Depending on the user's tendency, the device can send the data to the receiver only at the following certain time automatically:

When the vehicle is stopped.

When the vehicle starts moving.

When the vehicle door is opened.

When the vehicle is braked.

When an impact or an accident is detected.

Moreover, the automatic start of the device operation or an automatic help request can be done through detection of some signs, including the detection of a loud voice such as the user's shouting, detection of the utterance of a specific word by the user (by means of the sound and speech detection technology), or detection of a loud sound from the environment or other people.

Solution-26: The user can send the desired documents along with comments (explanations) to the receiver via the USB port (or BLUETOOTH or WIFI) built in the receiver in order to be stored on the receiver's memory. For example, the user can send the threatening individuals-related documents to the receiver via the USB port of the protection device in order to be registered on the receiver, providing a danger-inhibitory state for the user. The user can bold some cases as considerable threats in order to prompt the police to investigate these documents earlier in the case of the occurrence of an accident.

The functions of the keys are similar to what mentioned in the “Personal Protection device” section except that in the device designed for use in vehicles, the HELP REQUEST key can be mounted in the user's desired place, e.g. under the seat.

Additional points about the protection device for use inside vehicles:

For heavy vehicles such as trucks carrying cargos, especially expensive cargos, different types of the protection device can be used in the cargo loading section and in the driver-specific section inside the vehicle.

The audio, video and location types of the protection device can be used also for the money carrying vehicles.

The above-mentioned cases apply true for all types of vehicles.

All types of the protection device are also applicable for police vehicles, police motorbikes, . . .

Most of the points mentioned about the personal protection device apply true for the protection device for use in vehicles.

The protection device for use in vehicles needs no re-connection and re-disconnection and is always ready for recording and sending data.

### Invention C

### C—Protection Device as a Security System for use in Residential, Commercial, Office, . . . Units

The protection device for use in residential, commercial, and office units such as houses, shops, etc. can be used as a security system. the protection device as a security system will be described in the following sections. It should be noted that the protection device as a security system for commercial and office units is completely similar to the protection device for residential units.

### C.1—Protection Device as a Security System for Residential Units and Similar Cases

Solution-27: The security system that has the features of the protection device can be used for all residential units and similar cases. For using the protection device in buildings, that's enough for the protection device to have the capability to record and to send text, audio, and video to the receiver. The general model of the protection device as a security system for residential units and video door phone is shown in FIG. (9).

According to FIG. (9), different components of the protection device for residential units include:

It is similar to a cell phone and has a SIM card that provides the internet connection via cellular networks and sends the input data, immediately after being registered, to the receiver online.

It has a DSL wired input port that can receive data via wired lines of a local phone network.

It can be connected to the internet of wireless networks, . . .

It has a keyboard and a screen (for displaying the written information or camera pictures). The keyboard and the screen can be designed in provided in touch mode.

The keyboard (touch or external) can be used for entering the password for starting or stopping the operation.

It has an audio phone that can be used for making an audio connection with the visitor (the person who is standing behind the door and giving a buzz).

It has a built-in loudspeaker, microphone, and camera.

It can be connected to multiple microphones and external cameras (via wired or wireless connection).

When observing the videos of the cameras on the screen, shifting the cameras can be done by a touch keyboard.

It has an exterior panel consisted of a doorbell key, a microphone, and a camera. The exterior panel, like the common door phones, is mounted outdoor beside the entrance door. The exterior panel for the protection device as a security system in residential units and video door phones is shown in FIG. (10).

The exterior panel can include multiple doorbell keys for multiple units.

The protection device and cameras work with electrical power. So, it is better for the protection device and cameras to have an additional battery in order to continue operating in the case of power outages.

The protection device has a USB port or BLUETOOTH or WIFI through which it can receive data and send to the receiver.

The external keys of the device include:
SWITCH ON/OFF key
START/STOP key
HELP REQUEST key
TEST key
INSTANT FACILITIES DEACTIVATION key
ENTRANCE DOOR OPEN (and/or CLOSE) key

Place of the components of the protection device for residential units

The places of installation of the components, including the screen, camera, microphone, in residential units are as follows:

The screen is similar to the common screens in residential security systems, which is mounted on the device and is installed beside the entrance door or any other desired place.

The screen of the protection device mounted on the wall can show the pictures of the exterior camera or other cameras to the user.

The main section of the protection device, in which other components such as SIM card are placed, is mounted in the interior part and behind the screen. In other words, the exterior shape of the protection device for use in residential units is similar to the previous security system and is mounted on the interior wall of the house and has a screen.

The place of installation of camera and microphones

Depending on the user's tendency, the microphone and camera can be used in the following cases:

The microphone and camera can be mounted indoor or outdoor.

A camera and a microphone are mounted on the protection device and above the screen for indoor. This case can be used for registering the users' messages.

Depending on the user's tendency, in order for recording videos from the interior space, the camera can be mounted in other parts of the house.

The camera can observe and record the videos of the interior space as well as the face of the individuals who enter or exit the house. In other words, a camera and a microphone are mounted at the interior entrance to prevent destruction.

It is better to install a microphone in all places where there is a camera.

In the case of need and depending on the user's tendency, the number of cameras can be increased, especially in the outdoor space.

Installing a camera in the following places can be very useful:

At the entrance door in the exterior space to observe and record the picture of people.

In the outdoor space to observe the number plate of the cars parked in front of the house.

At parking lots or house garages to observe the status of automobiles.
Elevator
House yard

How it works:

According to FIG. (9), the protection device for residential units must be capable to record and send text, audio, and video, in which case the keyboard, microphone, and cameras collect data and then send the recorded data by the protection device to the receiver via the internet online.

How to start or stop the operation of the outdoor cameras and microphone (e.g. the microphone and camera on the exterior panel):

Solution-28: If there is no energy resource limitation and data transfer limitation, the protection device can, depending on the user's tendency, send the audio and video data of the outdoor space constantly. But, in order to reduce the contingent costs, or depending on the user's tendency, the device can send the data to the receiver only at certain times such as:
Doorbell buzzing
Door opening
Garage door opening
When the elevator stops at the floor where the user is living
Stop of automobiles in front of the house
Passage of people in front of the entrance door

For the last case, the movement detection cameras, which are installed at the entrance door or in the house yard, . . . , can be used so that the data are sent to the receiver as soon as being detected by the cameras.

How to start or stop the operation of the built-in microphone and camera on the device:

Solution-29: Starting or stopping the operation of the built-in camera and microphone of the device is done by the START key and depending on the user's tendency. Once the START key is pressed, the device starts recording and sending the audio and video of the user and the indoor space to the receiver to be registered on the receiver. At the same time, the exterior cameras and microphones are activated too, because a threat outside the house might have caused the recording of the message by the user.

Solution-30: If desired and for more safety, the built-in camera and microphone can be activated in the case of doorbell buzzing or door opening to send the audio and video of the visitor, after entering the house, to the receiver.

Solution-31: The operation of the device can be started or stopped by detecting special signs such as the detection of the user's shouting, the utterance of a specific word by the user (by sound and speech detection technology), or the detection of a loud sound from the environment or other individuals.

Solution-32: One of the most important features of the protection device for use in residential units is its capability to perform all duties of the audio and video door phones. This door phone (just like the previous systems) is capable to open (or close) the entrance door. Also, it has a big screen inside the house. Besides, the other features of the previous security systems can be added to this system too.

Other uses of the protection device in residential units include;

Most of the features of the personal protection device are the same as those of the protection device for use in residential units.

The user can send the desired documents along with the necessary comments to the receiver via the USB port (or BLUETOOTH or WIFI) embedded on the protection device in order to be registered on the receiver's memory.

The functions of the keys are similar to those of the personal protection device. the HELP REQUEST key in the protection device or use in residential units can be mounted on the protection device or any other desired place (e.g. near the entrance door, etc.).

In the case of the user's tendency, when the HELP REQUEST key is pressed by the user in the case of need, the device can make a direct and online connection to not only record the user's audio or video message but also send the messages to the police or the service-providing company (or the individuals predetermined by the use).

In addition to the new features, the protection device can have the feature of the previous security systems.

Similar to the previous security systems, in the case of observing a moving object in cameras, the device can warn the user by alarming.

Also, similar to the previous security systems, if the user is not at home, when the door is opened or a movement is observed in the cameras, the protection device can warn the user by sending an alarm or SMS or web-based message on the user's phone.

The protection device can be very useful for apartments.

To use the protection device in buildings, inexpensive methods such as the internet via fixed phone lines (ADSL), wireless internet, . . . , can be used. In the case of any error in sending the data by these two methods, the protection device can immediately use a SIM card (cellular networks).

The cameras and microphones can be connected to the protection device through wired or wireless connections or both.

### C.2—The Protection Device as an Audio or Video Door Phone

Solution-33: In fact, this is one of the secondary modes of the protection device as a security system in residential units, which will incur lower costs. Some people might not tend to or afford to buy the protection device as a security system for residential units so they can use the protection device as a video or audio door phone since it will incur lower costs.

The shape of this device for use as a video door phone is similar to those of the protection device for residential units (according to FIGS. 9 and 10). The protection device as a video door phone is capable to perform all duties of the audio and video door phones. This door phone has the capability to open (or close) the entrance door. It is equipped with a big screen that is mounted inside the house. This device can record and send audio and video to the receiver. Moreover, the features of the previous security systems can be added to it. In other words, features of the video (or audio) door phone and features of the protection device are combined to create a new type of door phone, which will have the features of the protection device too.

According to FIG. (9), different components of the door phone-type protection device include:

Similar to mobile phones, it has a SIM card that provides the internet connection via cellular networks and sends the data, immediately after being registered, to the receiver online.

It has a DSL wired input port, which can receive data via wired lines of a local telephone network.

It can be connected to wireless internet networks, . . .

It has a keyboard and a screen (for displaying the written information or camera pictures). The keyboard and the screen can be designed and provided in touch mode.

The keyboard (touch or external) can be used to enter the password for starting or stopping the device's operation.

It has an audio phone that is used for making an audio connection with the visitor (the person who is standing behind the door and has hit the doorbell).

It has a loudspeaker, a microphone, and a camera mounted on the door phone, which is placed inside the house.

It has an exterior panel consisted of a doorbell key, a microphone, and a camera (the exterior panel, similar to the commonly used door phones, is mounted outdoor beside the entrance door).

The exterior panel can include multiple doorbell keys for multiple units.

The protection device and cameras work with electrical power. So, it is better for the protection device and cameras to have an additional battery in order to continue operating in the case of power outages.

The external keys of the device include:
SWITCH ON/OFF key
START/STOP key
HELP REQUEST key
TEST key
INSTANT FACILITIES DEACTIVATION key
ENTRANCE DOOR OPEN (and/or CLOSE) key

Places of installation of the components of the door phone-type protection device

The places of installation of the components such as the screen, camera, microphone, . . . , in the protection device as a door phone are as follows:

The screen can be mounted on the door phone and on the wall beside the entrance door or any other desired place.

The wall-mounted screen can show the pictures taken by the entrance door camera to the user.

Components of the protection device, such as the SIM card, are placed inside the device (door phone) in the internal section behind the screen. In other words, the external shape of the protection device as a door phone is similar to that of the previous security systems and, thus, is mounted inside the house and has a screen.

The exterior panel is mounted outdoor beside the entrance door. It has a camera, a microphone, and a doorbell key. The camera and the microphone are placed above the doorbell key.

In the case of need and in the case of the user's tendency, the camera and the microphone can be used in the following places too:

The camera and the microphone in the indoor space are placed on the door phone above the screen. This state can be used for registering the user's messages and sending data to the receiver in the case of threats. The existence of the microphone and the camera on the protection device is not necessary. So both models can be presented so that the user can select one of them.

Moreover, depending on the user's tendency, the user can install a camera and a microphone in the internal section of the entrance door, which can be used for observing and recording the face of the people who enter or exit the house. The advantage of this camera and microphone is that they are invisible from outside the house.

How it works:

According to FIG. (9), the door phone-type protection device must be capable to record and send audio and video. In this case, the keyboard, the microphone, and the cameras collect the data and, then, send the recorded data to the receiver by the door phone via the internet online.

How to start the operation of the microphone and camera in the exterior panel

Solution-34: When the house owner switches on the door phone, the device is put on the standby mode. Then, if a visitor presses the doorbell key, the house owner can talk to the visitor via an audio or video communication and, if desired, open the door. Then, the door phone sends the recorded conversation between the visitor and the house owner to the receiver online.

Solution-35: If there is no energy resource limitation and data transfer limitation, the protection device can, depending on the user's tendency, send the audio and video data of the entrance door to the receiver constantly. However, to reduce the contingent costs or depending on the user's tendency, the door phone can send the data to the receiver only at certain times as follows:
Doorbell buzzing
Door opening
Garage door opening
When the elevator stops at the floor where the user is living
Stop of automobiles in front of the house
Passage of people in front of the entrance door

For the last case, the movement detection cameras, which are mounted on the entrance door, house yard, . . . , can be used so that as soon as detecting a movement by the installed cameras, the data are sent to the receiver.

A password can be set for starting and stopping the initial operation of the door phone.

How to start the operation of the microphone and camera on the door phone

Solution-36: Depending on the user's tendency, the operation of the microphone and camera mounted on the door phone can be started by a key. As the key is pressed, the door phone starts recording and sending the voice and video of the use as well as the indoor space to the receiver to be registered on the receiver's memory. At the same time, the microphone and camera on the exterior panel are activated too, because the existence of a threat outside the house might have caused recording the message by the user.

Solution-37: In the case of the user's tendency and for more safety, the camera and microphone on the door phone can be activated in the case of doorbell buzzing or door opening in order to send the visitor's audio and video, after entering the house, to the receiver.

Solution-38: Automatic operation of the door phone or help request can be performed by detection of some danger signs such as detection of the user's shouting or utterance of a specific word by the user (by the sound and speech detection technology) or detection of loud sounds of other people or environment.

Other uses of the door phone-type protection device

Solution-39: As many houses that use audio door phones, the door phone-type protection device can be used without a screen and camera so that only the audio data are sent to the receiver. This model is cheaper but it won't be as useful as the video door phone-type protection device. The audio door phone-type protection device is shown in FIG. (11).

Moreover, there is a middle model for the audio door phone in which the exterior panel can be equipped with a camera yet the door phone lacks a screen for displaying videos or pictures so the video data are only sent to the receiver.

Most of the features of the protection device for residential units apply true for the door phone-type protection device.

### C.3—Simple Protection Device for Residential Units

Some houses lack security systems and even door phones and the house owners don't tend to use instruments such as security systems or door phones. Or in some houses:

Only a simple doorbell is used.

A chain is attached to the door so that the user can lock the door by the chain before opening the door.

A hole is made on the door, through which the user can watch the outdoor space.

Solution-40: The simple protection device for residential units is shown in FIG. (12). In fact, the simple protection device is a secondary state of the protection device as the security system of residential units so that the protection device has been simplified. Thus, only the ENTER/EXIT data are recorded by the microphone and the camera and then sent to the receiver by the protection device. For such a case, that's enough for the protection device to have the capability to record and send audio and video to the receiver.

According to FIG. (12), the simple protection device for residential units consists of the following components:

It is similar to a mobile phone and has a SIM card that provides the internet connection via cellular networks and sends the input data, immediately after being registered, to the receiver online.

It has a DSL wired input port that can receive data on the internet via the wired lines of a local telephone network.

It can be connected to the internet of wireless networks, . . .

It has a keyboard.

In the simple protection device for residential units, it is not necessary to provide a screen for displaying the videos and pictures of the cameras. So the screen can be small and simple. Since the aim of this model is to provide a simple and inexpensive system, the data of the camera are sent only to the receiver, resulting in a danger inhibitory (deterrent) state for the user. However, in the case of the users' tendency, the model can be designed and provided with a touch screen (for displaying the videos and pictures of the cameras).

The keyboard (touch or external) can be used for entering the password to start or stop the operation of the device.

It has a loudspeaker and a microphone embedded in the device.

It has a camera and a microphone on the entrance door, which can be also installed in indoor or outdoor spaces.

It has a camera and a microphone above the doorbell key (in the exterior panel at the entrance door) just like the exterior section of a door phone.

The protection device and cameras work with electrical power so it is better for the protection device and cameras to have additional batteries so that they can continue working in the case of power outages.

The external key of this device include:
SWITCH ON/OFF key
START/STOP key
HELP REQUEST key
TEST key
INSTANT FACILITIES DEACTIVATION key

Place of installation of the components of the simple protection device for residential units

The places of the installation of the components, including the screen, the camera, the microphone, . . . , in residential units are as follows:

The main section of the protection device, in which the SIM card is placed, is similar to the previous security systems and can be mounted on a wall inside the house.

The protection device can, depending on the user's tendency, have a screen that is installed on the front side of the protection device and then mounted on a wall inside the house or beside the entrance door.

Place of installation of the microphone and the camera

Depending on the user's tendency, the camera and the microphone can be used in the following cases;

The microphone for use inside the house is mounted on the protection device. This state can be used for registering the user's messages. Installing or using the microphone on the protection device is optional and depends on the user's tendency and decision.

The camera and the microphone can be mounted in the internal section of the entrance door and are capable to observe and record the faces of the people who enter or exit the house.

The camera and the microphone can be mounted in the external section of the entrance door and are capable to observe and record the faces of the people who enter or exit the house. For instance, the camera and the microphone can be mounted above the doorbell key (on the exterior panel) just like the external section of the door phone.

How it works:

According to FIG. (12), the simple protection device for residential units must be capable to record and send audio and video. In this case, the camera and the microphone collect data and, then, send the data recorded by the protection device to the receiver via the internet online. The protection device records the audio and video of the person who presses the doorbell key (or knocks on the door) or wants to enter the house and then sends the recorded data to the receiver, providing a safe state for the user.

Most of the features of the protection device for residential units apply true for the simple protection device for residential units too.

How to start the operation of the microphone and camera for registering the data of the front door:

Solution-41: When the house owner switches on the device, the device is put on the standby mode. Then, if a visitor presses the doorbell key or knocks on the door, the house owner opens the door and talks with the visitor. In this case, the microphone and the camera record the audio and video of the visitor and, then, send the recorded conversation between the visitor and the house owner to the receiver online.

Solution-42: If there is no energy resource limitation and data transfer limitation, the protection device can, depending on the user's tendency, send the information constantly. However, to reduce the contingent costs or depending on the user's tendency, the device can be set to send the data of the front door only at certain times as follow:
Doorbell buzzing
Door opening
Passage of people in front of the entrance door

For the last case, the movement detection cameras, which are installed at the entrance door or in the house yard, . . . , can be used so that the data are sent to the receiver as soon as being detected by the cameras.

The device can require a password for the initial start/stop of the operation.

How the built-in microphone starts working:

Solution-43: The operation of the built-in microphone is started, depending on the user's tendency, by a START key. As soon as the START key is pressed, the device starts recording and sending the user's voice and the sound of the house environment to the receiver in order to be registered on the receiver. At the same time, the microphone and camera on the exterior panel are activated because the presence of a threat outside the hose might have caused the recording of the message by the user.

Solution-44: In the case of the user's tendency and for more safety, when the doorbell is buzzed or the door is opened, the built-in microphone can be activated in order to send the visitor's voice, after entering the house, to the receiver.

C.3—Protection Device as the Security system of Commercial, Office, . . . Units

Solution-45: Most of the points mentioned for the residential units can be also used for the commercial, office, . . . units. For example, the protection device can be used in banks, hotels, and many other cases too. For this purpose, it's enough to record the data by multiple cameras and microphones, which are mounted at the entrance door, interior space, and exterior space (e.g. parking) of a commercial unit, and then send the recorded data (including audio and video) to the receiver via the internet online. Also, the camera and microphone can be installed wherever needed depending on the function and on the demand of the relevant manager. For instance, for a hotel, the camera and microphone can be mounted in the lobby and corridors of the hotel.

Common features of the three inventions A, B, and C

The receiver device is common for all three inventions, as explained in the section related to invention A. The other points are explained in the following sections.

i. Registering and sending complementary information for all types of the protection device:

In this section, some of the user-related information for all types of the protection device is introduced, a part of which such as the identity and ownership information can be registered at the time of enrolment or can be later updated by the user. Moreover, there is also another part of the dynamic information that can be allowed by the user to be sent to the receiver online and automatically via cell phone, PC, . . . . In case of necessity, such information can be very useful.

a.1: Registering the identity and ownership information and similar cases:

Solution-46: It is certainly better to register the user's general information such as identity and ownership information for all types of the protection device. This case can be a complementary state for using the protection device since it provides further information about the user and can be very useful in case of necessity. The user can, in the case of tendency, register the following information in addition to his/her name so that, in emergency cases, it can be available for the police to facilitate helping the user:
National ID number
Various types of the protection device used by the user
Addresses of all of his/her houses
Addresses of all of his/her workplaces
All phone numbers
All models and number plates of his/her vehicles
Serial number of his/her mobile phone
MAC address of his/her PC, laptop, or other electronic devices
All email addresses along with relevant passwords
Usernames and passwords of all dating websites or social networks
Serial number of credit cards for pursuing the transactions
His/her bank account numbers (without password)

For example, if the user is lost, this information is quickly provided for the police to help the user.

a.2: Registering the user's dynamic information on the receiver automatically and online:

Solution-47: The user's dynamic information can be automatically registered on the receiver via a mobile phone, computer, bank SMS, email server, and similar ways. The user's dynamic information is registered automatically and online and is more complete than the identity and ownership information. The user can, in the case of tendency, allow the dynamic information to be registered on the receiver. Such information can include:

Sending all information of phone calls, recorded conversations, messages, and complete information of the user's mobile phone device to the receiver.

Sending the user's location, location of all of the user's vehicles, location of the user's mobile phone(s), location of the user's PC or laptop, and location of the user's smartwatch to the receiver online.

Sending the daily appointments among with the user's name and the appointment location via the user's mobile phone or PC.

Sending a copy of all emails and/or chats in different websites or social networks to the receiver, in which case the backup file can be sent to the receiver directly from the email server or the user's PC.

Sending the information of the time and location of the transactions of the user's bank accounts and credit cards to the receiver, in which case the SMS of the bank transactions can be sent to the receiver directly from the bank server.

In some cases, in which the dynamic information has been registered on the receiver, the user can bold some cases as a considerable threat. For instance, the user can save a recorded conversation as a threat so that the police can get access to it more quickly in the case of any accident.

a.3: Registering the information in emergency cases:

Solution-48: In emergency cases and in the case of the lack of protection devices or other access methods, the user can send his/her information or documents to the receiver through one of the following two methods:
1. The receiver has a mobile phone number so that the receiver, in fact, works as a phone secretary. The user calls this phone number and sends his/her message as an audio, video, or SMS message or even s/he can send his/her desired documents to the receiver in order to be stored on the receiver. The receiver's phone number can be the same as the user's phone number with a different code (pre-number).
2. The receiver has an email address. The user sends his/her message or information to this address in order to be stored on the user's receiver automatically. This email address can be the same as the user's email address with a different end address.

The user's desired information and documents can be sent to the receiver through one of these two methods. For instance, the user can send the threat-related documents along with necessary comments to the receiver via his/her mobile phone in order to be stored on the receiver's memory and provide a threat-inhibition state for him/her.

a.4: Sending the information related to some personal stuff, . . .

Solution-49: For all valuable business, home, and personal stuff, . . . , the audio-and video-type protection device, especially the location type device, can be used. For example, the protection device as associated tools such as GPS, microphone, and camera can be put inside expensive and valuable stuff, small lockboxes (safe) and jewelry safe boxes, frames of valuable tableaus and artworks, bank money boxes, etc.

Once the user is enrolled in the service-providing company, the company is informed that the user uses the protection device, e.g. the location type device, not only at home but also in some of the personal stuff or home appliances. So, in the case of a robbery or an accident for the house owner, the service-providing company can, with the help of the location type protection device put inside the house, receiver the information of the location of the home appliances from the receiver and give this information to the police and, therefore, the police can immediately help the user.

b—The ways of user's access to the registered information (for all types of the device):

As soon as the protection device sends a file to the receiver, the information is stored on the receiver's memory. The way through which the user can access the information stored on the receiver for reviewing, downloading, or deleting can be as follows:

b.1: Protection device

Depending on the used model, the protection device can have a screen and loudspeakers, in which case the information can be reviewed, downloaded, or deleted from the receiver with the help of the screen of the protection device. To review and download the information, the only thing that the user should do is to review the information on the receiver on the screen and through the loudspeakers. The information is registered and sorted based on the date and time. In this method, the user must use a password to get access to the review of the information.

In order for more security of the private information, the users can, in the case of tendency, disable (deactivate) the possibility of instant review, instant download, and instant deletion of the information or, in short, the instant facilities and features. In other words, for the information stored on the receiver, the feature of instant view, instant download, and instant deletion is not provided. However, after a predetermined time and confirming the request, the user can view, download, or delete the information.

The information is not stored on the protection device's memory. Thus, to view or delete the information, it can be viewed or deleted from the receiver's memory online.

b.2: Computer software and mobile phone application

In the second method, the users can use a computer software or a mobile application for reviewing, downloading, or deleting the information from the receiver. Such software or application needs an internet connection for connecting to the receiver. In this method, the user must use a password for entering the software and reviewing the information. For improving the security of the private information, the users can, in the case of tendency, disable the feature of instant review, instant download, and instant deletion of information or, in short, the instant facilities and features.

b.3: Internet website of the company

In emergency cases that accessing the protection device, computer software or mobile application is impossible, the users can refer to the internet website of the service-providing company for accessing or deleting the information from the receiver. In this case, by entering the personal password, the user can review, download, or delete the information registered on the receiver. Also, in the case of tendency, the user can completely disable the access to the information on the receiver through the third method (the internet website of the company).

To improve the security of the private information, the users can, in the case of tendency, disable the feature of instant review, instant download, and instant deletion of information or, in short, the instant features and facilities.

b.4: Private salon (hall) of the company

As the banks have a private salon (hall) in the safe-deposit box department for examining the content of the box by the box owner, a private salon is provided in the service-providing company that plays a role similar to that of the private salon in the safe-deposit box department of the banks. A user, to get access to his/her private information, can refer in presence to this private salon and get access to his/her information by receiving a receiver. Since in this method the user refers to the private salon lonely, nobody other than the user can have access to the information.

To improve the security of the private information, the users can, in the case of tendency, disable the feature of instant download and instant deletion of the information in the fourth method. In other words, in this case, the user's information is stored on the receiver's memory and the information is observable. However, it is not possible to instantly download and instantly delete the information so that, in emergency cases, no one can enforce the users to download or delete their information from the receiver. Of course, in the fourth method, the feature of instant review can be always activated since nobody other than the user can refer to the private salon for receiving the receiver.

To sum up and to compare all access methods, as mentioned earlier, improving the security of the private information necessitates deactivating all instant facilities in methods 1, 2, and 3. If so, in these methods, the users can review, download, or delete the information after, for example, two weeks. Furthermore, in the case of need for instant review of the information, the users can refer to the private salon according to method 4. In method 4, i.e. the private salon, it is better to disable the feature of instant download and instant deletion of the information.

Methods 1, 2, and 3 are simple in terms of accessibility. By deactivating the instant facilities (deactivation of instant review, instant download, and instant deletion of information), almost all advantages of the private salon method, except the instant review of information, are achieved and the users, in the case of tendency, can instantly review their information merely through the private salon method.

In other words, the user can completely disable access to the information on the receiver through all methods so that the review of the information would be possible only through the fourth method. This case meets all goals of the protection device. The protection device has been designed for accessing the information in emergency conditions not for reviewing and publishing the information by the user.

c—Proposed Principles for Deactivating and Managing the Registered Information:

In the following sections, some of the proposed principles for working with the protection device and the receiver device are explained in detail. Taking these principles into consideration provides the users with many advantages.

c.1: Some points about deactivating the feature of instant review, instant download, and instant deletion of information:

Solution-50: To improve the security of the private information, the users can, in the case of tendency, disable the feature of instant review, instant download, and instant deletion of information registered on the receiver. In this case, the user's information is stored only on the receiver's memory. For example, disabling the instant deletion of information means that if the user's password is revealed, nobody will be able to instantly delete the user's information from the receiver. Also, in the case of disabling the instant review and instant download feature, if the user's password is revealed, nobody will be able to review and download the user's information, thus disabling these instant facilities and features will provide a high level of privacy and security for the user.

In this case, in which the feature of instant review, instant download, and instant deletion has been disabled, in order to review, download, or delete the information of a desired period, the user sends a request to the receiver by means of the protection device but the receiver puts the user's request into action after a certain time interval, e.g. after two weeks. Such a two-week period is called the “instant facilities activation time”. For the activation of the instant facilities, the two-week period is recommended. In this regard, the longer the time interval, the higher the security of the users and the security of the users' information.

For example, imagine that the feature of instant review, instant download, and instant deletion of information is disabled and the user sends a request to the receiver for deleting File (a) and reviewing File (b). Two weeks after the user's request:

With the final approval (confirmation) of the user, File (a) is deleted. Also, at the time of the final approval for deleting File (a), the user can review it again to prevent deleting the information mistakenly.

The feature of reviewing File (b) is enabled for two days and the user can review File (b) during these two days. Once these two days are passed, the feature of reviewing File (b) is disabled again whether the user has reviewed it or not.

In the above case, at the time of requesting for reviewing File (b), the user can, in the case of tendency, can activate any desired time interval instead of the two-day period. However, the shorter the duration of the activated feature, the higher the security of the user's information.

In addition, in the above case, at the time of requesting for reviewing File (b), the user can, in the case of tendency, enable the feature of reviewing File (b) forever instead of the two-day period.

Disabling the feature of instant review, instant download, and instant deletion of information has the advantage that during these two weeks, the user can confirm or reject his/her request. For example, the receiver sends an automatic notification message to the protection device or through the other above-mentioned access methods (e.g. user's mobile phone or PC). This message delivers the primary request message to the user and the user can confirm or reject the primary request.

c.2: Switching between activation (enabling) and deactivation (disabling) of instant facilities:

The users can, depending on their tendencies, enable or disable the instant facilities (instant review, instant download, instant deletion of information).

The users can disable the instant facilities (instant review, instant download, and instant deletion of information) at any desired time and the instant facilities will be immediately disabled.

In the case that the instant facilities (instant review, instant download, and instant deletion of information) have been disabled by the user, if the user wants to re-enable each of them, the instant facilities will be re-enabled after two weeks since the activation requested is registered and will remain in the activated mode for a limited time, e.g. for two days.

Taken as default, the activation time of the instant facilities and the duration of the activated mode of the instant facilities are presumed two weeks and two days, respectively. The users can change these periods to their desired times. But, notice that it is better to set the activation time of the instant facilities longer and the duration of the activated mode of the instant facilities shorter.

In the case of the user's tendency for full activation of the instant facilities (instant review, instant download, and instant deletion of information) for an unlimited time, the instant facilities will be activated unlimitedly after two weeks since the registration of the activation request (of course, this is not recommended).

c.3.1: Selection of information for deactivating instant facilities:

In order for simplicity and also for higher security of the users' information, in the default settings of the protection device, if the instant facilities are disabled by the user, this deactivation of the instant facilities will be applied to all information (including all the information that has been previously, is being currently, and will be registered in future).

For example, if the user has 14 files of registered information and disables the instant facilities, in the default mode, the instant facilities are disabled for all 14 previously registered information and also for the subsequent information.

If the instant facilities are enabled, the users can, in the case of tendency, disable the instant facilities only for some of their information in the SETTINGS of the protection device or SETTINGS of other methods. For example, if the user has 14 information files, in the case that the instant facilities are enabled for all 14 information files, the user disables the instant facilities only for the desired information f. But, disabling the instant facilities for multiple certain information files is not recommended since it might cause the user's confusion and disclosure of their information. Thus, it is better to disable the instant facilities for all information files, nevertheless, it is the user that makes the final decision.

Another advantage of disabling the instant facilities for all information is that the instant facilities of the information, which is being currently registered or will be registered in the future, are disabled as soon as the information is registered. As a result, the information, as soon as being registered, becomes safe and inaccessible for others and also impossible to be deleted.

c.3.2: Selection of information for activating instant facilities:

If the instant facilities are disabled, the user can activate the instant facilities of the registered information related to, for example, the past month in order that this information becomes accessible for the user after two weeks for two days so that s/he can observe, manage, and select the desired information.

c.4: Deleting the registered information:

For a better understanding, this case is divided into three states:

c.4.1: Deleting the registered information in the case of enabled instant deletion or activation of all instant facilities:

In this case, after the user's request for deleting a file or an information, the information is deleted from the receiver instantly. However, the activation of instant facilities is not recommended.

c.4.2: Deleting the registered information in the case of disabled instant deletion:

If the instant deletion is disabled and the instant review and instant download are enabled, once the user requests deleting a file (information C), the instant review and instant download of that file are also deactivated for two weeks. As such, the obtained results are the same as that of the instant deletion of the information C and the file becomes inaccessible for two weeks.

For example, in this case, imagine that the user, after observing his/her information, requests deleting the particular information g. If so, all three types of instant facilities of the information g are deactivated for two weeks. After two weeks, the instant deletion of the information file g is activated again and the user can confirm the deletion of the particular information g.

c.4.3: Deleting the registered information in the case of deactivation of all instant facilities:

As mentioned earlier, for simplicity, in the default mode of the first three access methods, all three facilities (features) of instant review, instant download, and instant deletion are disabled altogether or, similarly, all of them are enabled altogether.

In the default mode, in which all three instant facilities are disabled, the information cannot be observed and reviewed. In such conditions, when a user wants to delete a part of his/her information, s/he might fail to segregate the information. The information is registered and sorted based on the date, time, . . . , thus the user can discriminate and identify his/her desired information regarding the date and time or based on names. If the user wants to delete certain information, s/he can request activating the instant facilities of a bigger set of information over a period of time, e.g. the past month. As such, after two weeks, this set of information is activated and the user can review the whole information of that one-month period, find his/her desired information, and then delete it.

The advantage of this feature is its simplicity. Another advantage is that at the time of the final deletion confirmation, the user can review the information in order to prevent any mistake in deleting the information.

Another method for deleting the information is the fourth method, i.e. the private salon method. Since reviewing the information is always possible in the fourth method, the user can go to the private salon directly and ten, after observing and investigating the information, delivers his/her request for deleting the desired information in order that the desired information is deleted with the final confirmation after two weeks.

c.5: Management of the registered information:

In the case that the instant facilities are disabled, in order to manage the registered information (for example, to manage the information of the past month or delete the excess information), the user can enable the instant facilities of all information of the past month. Two weeks after this request, the instant facilities of all information of the past month are enabled for two days. Then, during these two days, the user can review, download, or if desired, delete the whole information registered during the past month. Moreover, to manage the registered information, the user can use the fourth method.

If the disappearance of the user is reported by his/her family or relatives during the two-week period of the activation of the instant facilities, as soon as the company is informed of this issue, all requests of review, download, and deletion of information are canceled from all methods.

As mentioned earlier, for simplicity and in order that the protection device can be applicable for all people, in the default mode of the first three methods, all three features of instant review, instant download, and instant deletion of information are either deactivated or activated altogether.

If a user tends to disable only one or two instant facilities, s/he can do this in the ADVANCED SETTING. For example, for particular information u, the user can enable the instant review and disable the instant download and instant deletion. However, disabling one or two instant facilities might cause the user's confusion and also disclosure of their information. The best case is the one in which all of the instant facilities (instant review, instant download, instant deletion of information) are disabled by the user. In any case, it is the user that finally decides which facilities should be disabled or enabled.

In the case of deactivated instant facilities, the user can request for reviewing, downloading, or deleting the information, but the information is presented to the user after two weeks and for two days. In this case, the process of confirmation by the user can be as follows:

The user requests the activation of the instant facilities of the information k in order for reviewing or deleting.

First, a message is sent from the receiver to the protection device or other above-mentioned methods (user's mobile phone or PC) and is, then, displayed for the user. This message informs the user of the primary request.

After two weeks, the user must confirm the activation request of the instant facilities of the information k by one of the above-mentioned methods. In this case, the information k becomes accessible for the user for two days. During these two days, the user can review, download, or delete the information k.

Enabling or disabling the instant facilities (instant review, instant download, instant deletion of information) can be done by the protection device or one of the above-mentioned methods.

c.6: Naming and prioritizing the information:

All the information in the receiver is registered and sorted automatically based on date and time.

Naming the information for a text type device can be done at the time of sending the information. For example, when a text-type information is being written, a desired name can be assigned for it. Also, when the user is registering the information in the text-type device, s/he can register the priority level of the information.

Moreover, when starting (or even finishing) the registration of a particular audio or video information, the user can define a desired name for the registration of that particular information or provide some comments and describe the priority level of the information.

The users can put the desired name on the information when reviewing and observing the registered information or, in the case of tendency, change the name and mention the priority level of the information.

The user can bold the serious threats of the individuals by naming and ranking them as, for example, “important threat”. In this case, if an accident occurs for the user or if the user disappears, the police focus on this information sooner and put more emphasis on it.

c.7: Information registration period:

If a user doesn't delete his/her information from the receiver, the information will be archived on the receiver's memory for a certain period of time known as the “information registration period” and won't be deleted. The reason is that in the case of any accident for the user or in the case of the disappearance of the user, the registered information on the receiver can provide the ground for helping the user or preventing threats to him/her. As soon as this period is passed, the information is automatically deleted from the receiver. The users can, if desired, consider any longer or shorter period for this purpose. This is done in order to reduce the information registration and maintenance cost to a large extent. If there is no storage limitation or economic limitation, this period can be very longer.

This feature is also applicable for periods much longer than one year, especially for the text-type and location-type devices, since the text-type and location-type devices don't need much space for the storage of information. Moreover, registering the fundamental threats against the users for long periods can provide higher reliability for the users' security.

Also, the user can specify some important information to be kept and not deleted even after the “information registration period”.

d—General points for all types of the protection device:

d.1: Transfer of information [data transfer] (from the protection device to the receiver or vice versa):

Solution-51: To transfer information (data) from the protection device to the receiver (or vice versa, for example, when reviewing the information by the protection device), the internet of the cellular networks, which is provided by inserting a SIM card in the protection device, is used. In other words, the protection device functions as a mobile phone, which transfers the information. In addition, other methods of accessing the internet or other methods of data transfer such as local networks, wireless networks, internal (domestic) networks, satellite communication, house WIFI internet, or any other wireless data exchange space can be used for this purpose.

As for the receiver, in addition to the above-mentioned methods, data transfer can be done through other methods such as the internet of fixed phone lines, optic fibers, and wired networks. Moreover, for the protection device in residential, commercial, . . . complexes, data transfer methods similar to those of the receiver can be used.

It is better for the receiver and the protection device to be capable to use two or more data transfer methods at the same time. So, in the case of any disorder in one method, it will be automatically replaced by another method for data transfer.

As for the receiver and the protection device for residential, commercial, . . . complexes, in the default mode, the inexpensive internet of fixed phone lines (or wireless networks) can be used, which will be replaced by wireless methods such as the internet of cellular networks, . . . in the case of any error in the data transfer process.

In some countries, a combination of multiple methods (national Information Network) is used for data transfer. The National Information Network can be also used for the current plans.

In order for a safe transfer of data, the data can be encrypted before being sent.

In the case of the lack of cellular networks or the internet, the protection device can use satellite communication methods such as the satellite internet. This particular case is important especially at the time of pressing the HELP REQUEST key in order that whenever the user needs help and there is no communication way other than satellite communication, the user can send his/her HELP REQUEST along with the last location determined by GPS to the police or those predetermined by the user. The satellite internet can be used especially for the vehicle-type and the residential unit-type (house type) devices.

d.2: How to inform the police or the company of the emergency cases for helping the users:

Solution-52: Besides having the protection device and the receiver, the user must necessarily enroll in a security service-providing company in order to register the user-related information, which has been stored on the receiver's memory, in that company. In a simple case, if an accident occurs for an individual, e.g. the individual is lost, the police inquire that individual's name from the company and if s/he has enrolled in the company, then the company will give the information of that person to the police.

In the general case, in the case of any accident for the user, the user's information is given to the police and there is no need for giving the user's information to his relatives unless the user has demanded it. In other words, the user can determine some individuals in order that, in the case of any accident for the user, his/her information is given to these individuals in addition to the police.

The user can request for informing the police of his disappearance with a time delay. For example, if the user becomes inaccessible for a certain period, e.g. 24 hours, his/her information is given to the police or the predetermined individuals. It is recommended to consider no time interval for the police.

In addition, the user can determine that his/her information is never given to the police and is given only to some specific individuals such as his/her family although this is not recommended. Moreover, to avoid giving information to the police will weaken the guarantee of the users' security and the trust in the plan. However, in the general case, the user is authorized to decide to whom the information should be given.

d.3: Items that should be executed by the service-providing companies:

The companies that work as “alarm monitoring centers” can also work as the service-providing companies for the current plan.

The service-providing company is capable of 24-hour and online responding to the police.

A notable point is that all users can enroll in the service-providing companies only by their real names and information along with their national ID number and passport number. The enrollment of the users with unreal names is not credible.

It should be clarified that each user uses which type of the protection device. In this case, for example, if a user who has a combined-type and vehicle-type device disappears, the police will know that it should initially look for the last location of the user in the receiver and then examine the other items.

The police are informed only when an accident occurs for the user or the user disappears.

In the case of the user's tendency, if the user records no new information after a certain time (e.g. two weeks), the service-providing company or the police will call the user to make sure of his/her health. The duration of this time period can be selected by the user.

In the case that the protection device is stolen or the user's password is disclosed, or in the case of an accident for the user or other similar cases, if the instant facilities are disabled, there will be nothing to be worried about but in such cases, if the instant facilities are enabled, the company will deactivate the features of reviewing, downloading, and deleting the information in the first three access methods or, in other words, it will deactivate the access and deletion of the information.

d.4: Connection and coordination between different types of the protection device such as the personal-type and vehicle-type devices, or mobile application and camera in a vehicle:

Solution-53: In the cases that the user applies multiple types of the protection device, there can be a coordination between different types of the device.

For example, imagine that the user's personal protection device is a smartwatch on his/her wrist, and also a protection device is installed in his/her vehicle. Now, imagine that the user gets off his/her vehicle in a far place and goes to visit a person. Due to the lack of common communications, the personal protection device (smartwatch) cannot send the information or the HELP REQUEST to the receiver and the smartwatch cannot have satellite communication. In such a case, the user's smartwatch sends the information or the HELP REQUEST to the vehicle-type protection device. Then, the vehicle-type protection device transfers the information or the HELP REQUEST to the receiver via satellite communication, and the receiver informs the police or the predetermined individuals of the help request.

As another example, when the user gets off the vehicle and goes toward a place, the vehicle-type protection device receives the direction of the user's movement (user's destination) from the personal-type device and the external cameras of the vehicle record the user's video.

As another interesting example, the camera is mounted inside or outside the vehicle and the data are sent to the receiver by a mobile application (for example, it is activated in the case of danger or detection of a loud sound).

d.5: Other items for all types of the protection device:

This section includes some detailed points about all types of the protection device.

The protection device's memory is temporary and, thus, the protection device cannot store information. Therefore, when the user wants to review the information, the protection device displays the information online. If the user wants to download and extract the information, the information is transferred directly from the receiver to the USB or BLUETOOTH or . . . and is not stored on the memory of the device.

Various types of the protection device can be also used for police forces, motorcycles, and police cars.

The protection device can be switched on and operated by the user's fingerprint and iris scan.

Even if the protection device is stolen (in the case of personal use) and lost, it still continues collecting and registering information. For instance, in the case of the location-type protection device, the device can send the thief's location to the receiver.

In all types of the protection device such as the personal, vehicle, house, and other types, it is recommended to install the device in a place that all individuals or, at least, close ones near the user can observe the device. If so, it will prevent crimes and also prevent bothers or threats to the user.

It is better to produce and supply all types of the protection device as well as their accessories in a single color (e.g. green) since the people around the user, by seeing this color, will understand that the user has a protection device. As such, the protection device will provide security for the users. In other words, producing the protection devices in a single color causes better recognition of these devices by the people around the users. However, depending on the user's tendency, different types of the device can be produced in other colors.

Some features of the previous security systems can be used in this product. For example, for some types of the protection device, which are used in commercial and non-personal applications, depending on the user's tendency, the device can be designed in such a way that it can provide a live display of the information for the user in addition to registering the information on the receiver's memory. For example, the user can watch his/her shop (store) online while sitting at home.

The documents and some important information can be sent to the receiver by all of the four above-mentioned access methods.

e—Protection Device-Related Softwares

e.1: Mobile application and computer software instead of the text type personal

protection device:

Solution-54: The mobile applications and computer software can replace the protection device in the text-type protection device (personal use) for registering the user's information. In this case, the software will have all features and capabilities of the text-type protection device. So, the user can register his/her textual information by the mobile application or computer software to be sent to the receiver.

The advantage of using a mobile application or computer software instead of the text-type device is that the advantages of the protection device can be introduced for the people in the society; besides, the citizens' security can be provided at an insignificant cost.

e.2: Mobile app instead of the location-type personal protection device:

Solution-55: The location-type software can be provided instead of the location-type protection device. this software can position and determine the user's location by GPS or other available methods on the mobile phone and send it to the receiver and, thereby, the user can enjoy the advantages of the location-type protection device. in this case, the software has all features and capabilities of the location-type protection device.

e.3: Mobile application and computer software instead of different types of the personal protection device:

Solution-56: For personal use of the protection device, a software can be designed for mobile phones in such a way that a single software can be used instead of multiple types of the protection device. This means that, by using this software, the information is recorded and sent to the receiver.

In this case, the software has all features and capabilities of the protection device. For example, starting the operation can be done manually or automatically. The automatic operation of the software (or automatic help request) can be done by the detection of some signs such as running or heartbeat, the detection of a loud sound such as the user's voice, or utterance of a specific word by the user (using the voice and speech detection technology), and the detection of loud sound from other people or from the environment. For this purpose, the software collects the audio and video information from the user and the environment and sends it to the receiver.

Similarly, the computer software can be also used for some applications such as the text-type, audio-type, and video-type.

In the case of using a mobile app for the audio-type and video-type devices, after installing the mobile app, other additional equipment should be purchased depending on the user's tendencies. For example, the user can buy a wearable microphone or camera or a separate camera for the vehicle. The connection between the mobile phone (or computer) and the microphone and camera can be via a wireless connection.

Also, the user can use the mobile app and the protection device at the same time. For example, when the mobile phone is accessible, s/he can use the text-type software instead of the protection device.

e.4: Mobile application and computer software for accessing the information (all types):

Solution-57: According to the abovementioned points, to access and manage the information in different types of the protection device and for different applications of the device, the mobile app and computer software can be used.

### BRIEF DESCRIPTION OF DRAWINGS

FIG. 1: Text type protection device (for personal use) (Invention A)

FIG. 2: Audio type Protection device (for personal use) (Invention A)

FIG. 3: Video type Protection device (for personal use) (Invention A)

FIG. 4: Location type Protection device (for personal use) (Invention A)

FIG. 5: Combined type Protection device (for personal use) (Invention A)

FIG. 6: Key-holder as personal protection device (Invention A)

FIG. 7: Receiver device (Invention A, B, C)

FIG. 8: Protection device for use in vehicles such as automobiles, motorbikes, etc. (Invention B)

FIG. 9: Protection device as the security system of residential building and video door phone. (General model of Invention C)

FIG. 10: Exterior panel for the protection device as the security system for a residential unit and video door phone (Invention C)

FIG. 11: Protection device as audio door phone (Invention C)

FIG. 12: Simple protection device for residential units (Invention C)

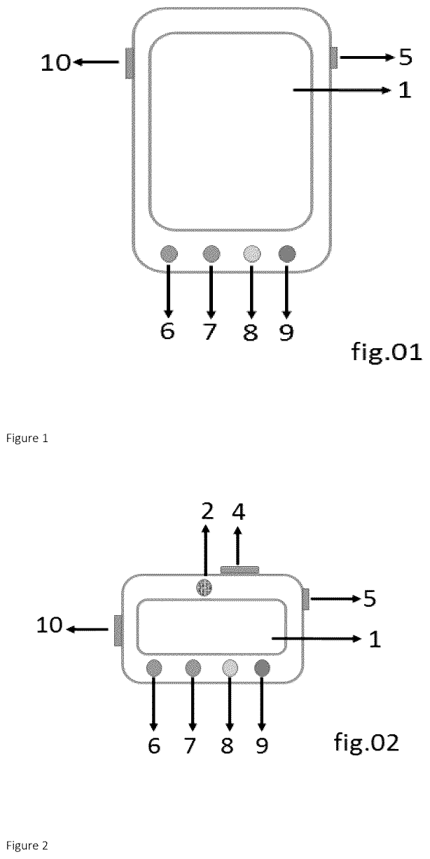

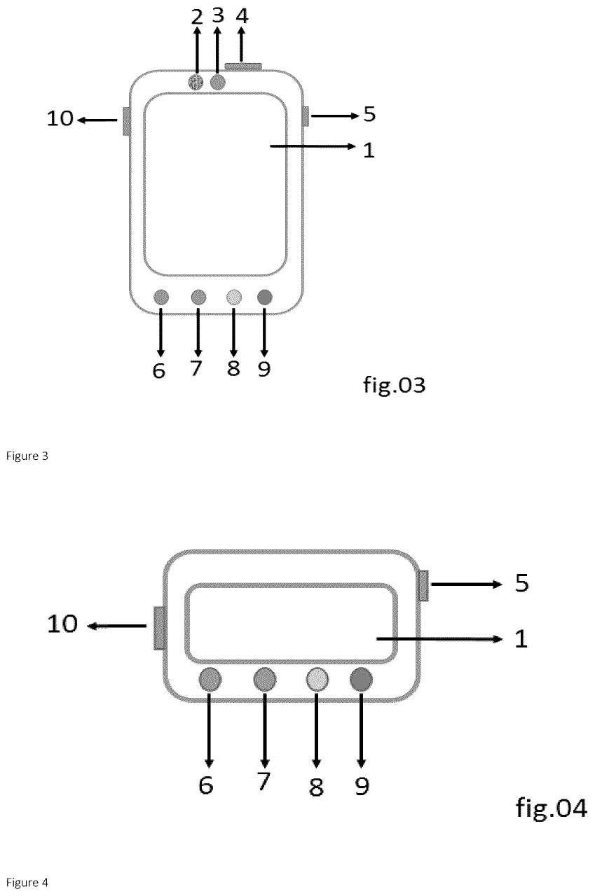

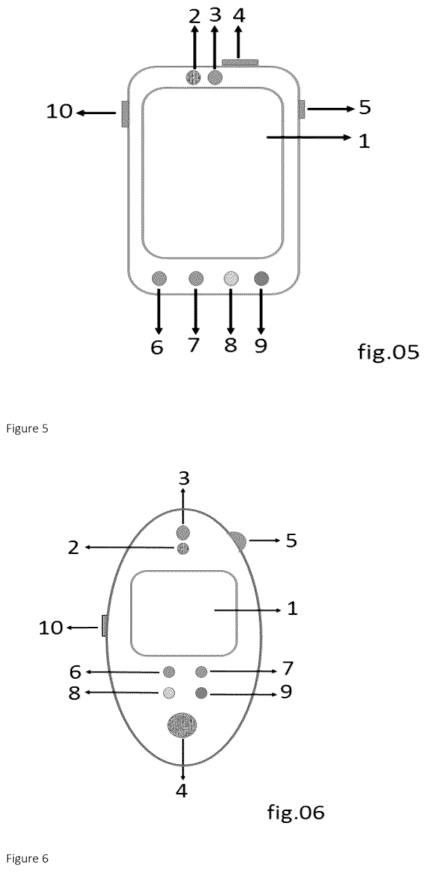

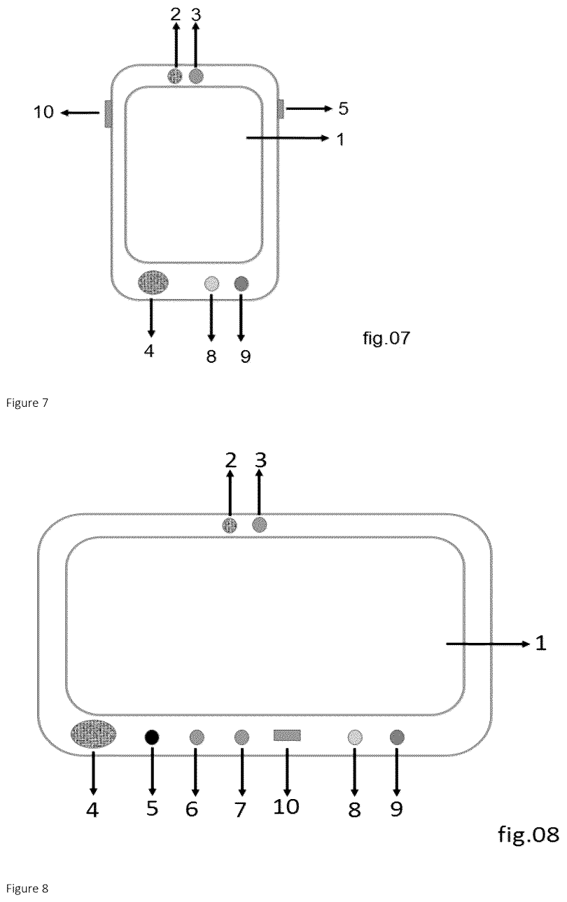

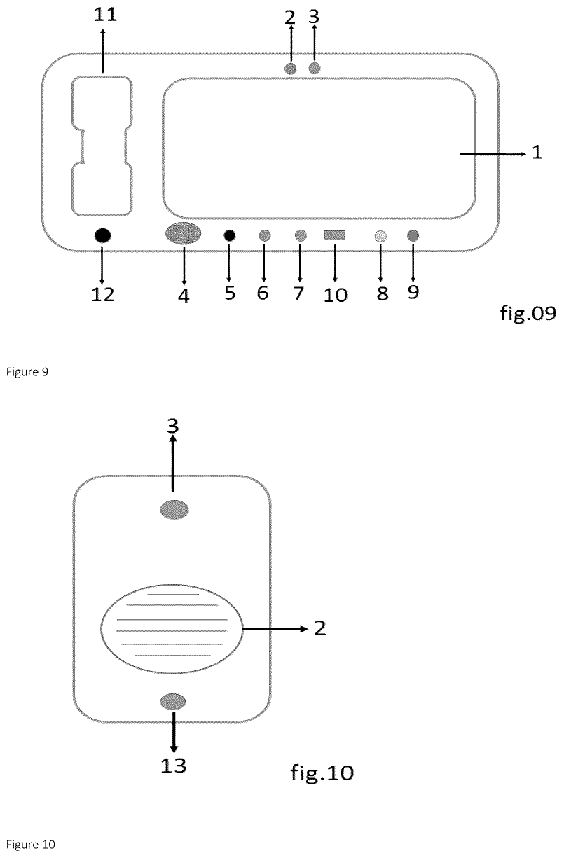

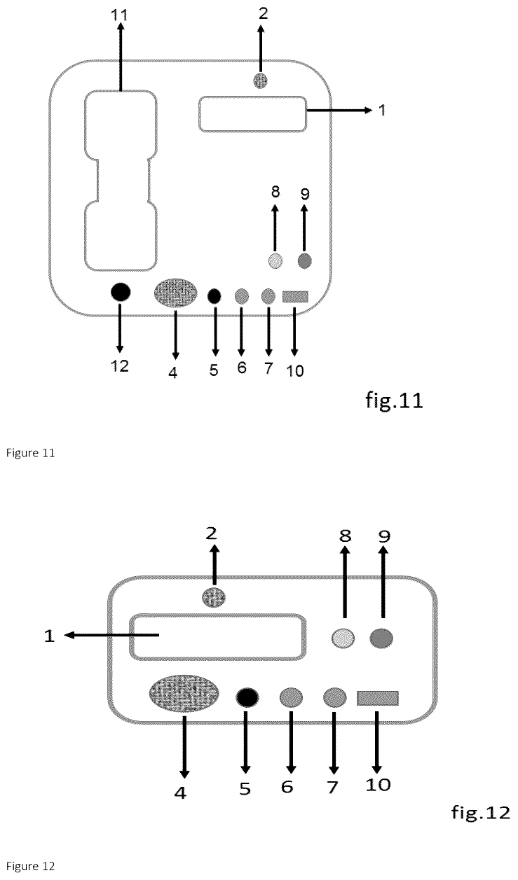

### DETAILED DESCRIPTION OF THE INVENTION

The components corresponding to the numbers in the figure are as follows:
a. Touch screen and keyboard or simple screen; (2) Microphone; (3) Camera; (4) Loudspeaker; (5) SWITCH ON/OFF key; (6) START/STOP key; (7) TEST key; (8) INSTANT FACILITIES DEACTIVATION key; (9) HELP REQUEST key; (10) USB port or device charger port; (11) Audio phone (for residential units); (12) ENTRANCE DOOR OPEN (and/or CLOSE) key (for residential units); (13) DOORBELL key on the exterior panel (for residential units).

The SIM Card, the wireless internet, WIFI, Bluetooth, and GPS equipment, and battery in the receiver and all protection devices are installed behind the screen in the interior part.

In the receiver and the protection device for use in residential units, the wired internet port is mounted beside or behind the device.

For small protection devices such as audio-type, location-type, and key-holder for personal use, and also for simple protection devices for residential units, the screen can be small and even simple. In this case, a navigation key and also a keyboard can be used too.

According to FIG. (7), the receiver has a screen. Of course, the receiver can be designed with no screen or with a small and simple screen. In this case, in order to display the information, the receiver can be connected, in addition to the protection device and other aforementioned access methods, to a monitor, a computer, or a cell phone.

Component (10) in all protection devices for personal use is the place where the USB port and the charger port are mounted.

Component (10) in the receiver, in the protection device for use in vehicles, and in the protection device for residential units is merely the place of the USB port since these devices are charged by a power supply wire, which is placed beside or behind the device.

The USB port in small protection devices such as the audio-type, location-type, smartwatch, key-holder for personal use, and simple protection device for residential units can be provided as a Type-C USB port. No figure or drawing has been provided for the smartwatch as a personal protection device since the smartwatch protection device is exactly similar to the current smartwatches, and all keys of the smartwatches are not necessarily external and can be activated by the touch keyboard of the screen. Moreover, the capabilities of the protection device can be added to the capabilities of the commercially available smartwatches, in which case the smartwatch will have much more capabilities and features compared to the previous models.

1. The invention “Protection Security Device with Threatening Individual(s)' Information Registration Capability” includes three inventions A, B, and C for different applications. In section A, the invention for personal use, in section B, the invention for use in vehicles, and in section C, the invention for use at homes (and commercial uses) are described. In each of these inventions (i.e. A, B, and C), the security device is constituted of two components, namely the “protection device” and the “receiver”. The protection device collects the information and then sends the collected information to the receiver online. The receiver is a device on which the information is registered. The duty of this invention is to increase the users' security by accelerating the data transfer to the police for helping the users in the case of accidents.

2. Based on claim 1, the protection device consists of a textual information registration module including a keyboard, an audio information registration module including a microphone, a video information registration module including a camera, a location positioning module including GPS, and a USB port. All of these modules are responsible for recording the input information. In addition, the protection device has a screen and a battery.

3. Based on claim 1, the protection device has a wireless connection module for connecting to wireless networks and a SIM card, which provides the internet connection via cellular networks.

4. Based on claim 1, the receiver device has a wireless connection module for connection to wireless networks and a SIM card, which provides the internet connection via cellular networks and receives the information from the protection device online and registers on its memory. Also, the receiver has a DSL-technology wired input port, which can receive the information from the internet via the wired lines of the local telephone network. Besides, the receiver device can be connected to other internet networks such as WIFI.

5. Based on claim 4, and also considering the users' tendencies, some other forms have been provided for the receiver device, which include: “receiver device in portable form, central computer of the security service-providing company as the receiver, cloud space as the receiver, and a separate memory storage for each user as the receiver”.

6. Based on claim 1, the basis of operation of this device is such that the protection device records the user's information (textual, audio, video, and location) via the keyboard, GPS, microphone, and camera and then sends the recorded information to the receiver online via the internet. The information will be stored on the receiver's memory. In the case of any accident for the user, the police will be able to help the user by using this registered information.

7. Based on claims 5, and 6, in order to provide safe conditions for preventing crimes and protecting the user, the receiver is located at a safe place far from the crime scene so that the user-related information cannot be accessed and deleted immediately. For example, the receiver is located in the security service-providing company (For example Alarm Monitoring Center companies).

8. Based on claim 6, the operation of the protection device is in two automatic and manual forms. Accordingly, registering and recording the information is activated either manually by the user or automatically based on the predefined operators such as “pressing the doorbell key, opening the house door, the detection of a loud sound from the user or the environment, user's running, user's high heart rate, the utterance of a specific word by the user, etc.”

9. Based on claim 1, the protection device for personal use is provided in multiple forms, one of which is the smartwatch (or smart wristband). Also, the features and capabilities of the current protection device can be added to the smartwatches (or smart wristbands) available in the market.

10. Based on claim 1, the protection device for use in residential (and commercial) units is provided in multiple forms. One of these forms is the audio and video door phone in which the features of the protection device and those of the audio and video door phones (such as opening the entrance door and audio-video conversation with the visitor) have been combined and the videos will be stored on the receiver's memory. Moreover, features of the current protection device can be added to the audio and video door phones available in the market so that the audio and video are sent to the receiver online and then stored on the receiver's memory.

11. Based on claim 1, depending on the users' tendency, the users can use a mobile app or a computer software instead of the protection device (for recording the information) to send the information to the receiver. In this case, the software will have all features of the protection device, thus, the protection device won't be needed anymore and the information will be stored on the receiver's memory.

12. Based on claim 1, to provide safe conditions for protecting the user's security and privacy and preventing the criminals' access to the user's information, the current invention is capable to deactivate the instant facilities. Based on this feature, the user's information (which has been registered on the receiver) cannot be accessed and deleted immediately.
